(19) United States
(12) Patent Application Publication
(10) Pub. No.: US 2024/0023557 A1
(43) Pub. Date: Jan. 25, 2024

(54) COPPER-BASED FUNGICIDE COMPOSITION

(71) Applicants: Sheron Fransisco DE OLIVEIRA, PW Wageningen (NL); Shimom AMSELEM, Rehovot (NL); Adama Makhteshim Ltd., Beer Sheva (IL)

(72) Inventors: Sheron Fransisco De Oliveira, PW Wageningen (NL); Shimon Amselem, Rehovot (IL)

(73) Assignee: Adama Makhteshim Ltd., Beer Sheva (IL)

(21) Appl. No.: 18/255,487

(22) PCT Filed: Dec. 2, 2021
(86) PCT No.: PCT/IB2021/061258

§ 371 Date: Jun. 1, 2023

Related U.S. Application Data
(60) Provisional application No. 63/120,575, filed on Dec. 2, 2020.

(51) Int. Cl. A01N 59/20; A01N 43/40; A01N 43/653; A01P 3/00; A01N 25/22; A01N 25/24; A01N 25/04

(52) U.S. Cl. CPC A01N 59/20; A01N 43/40; A01N 43/653; A01P 3/00; A01N 25/22; A01N 25/24; A01N 25/04

(57) ABSTRACT

The present invention relates to combinations and compositions comprising a copper-based fungicide and a polyelectrolyte. The invention further relates to methods of preventing, reducing and/or eliminating the presence of a phytopathogen on a plant or on one or more plant parts, comprising applying a combination or composition of the present invention to said plant or plant part.

Throughout this application various publications are referenced. The disclosures of these documents in their entireties are hereby incorporated by reference into this application in order to more fully describe the state of the art to which this invention pertains.

### FIELD

The present invention relates to combinations and compositions comprising a copper-based fungicide and a polyelectrolyte. The invention further relates to methods of preventing, reducing and/or eliminating the presence of a phytopathogen on a plant or on one or more plant parts, comprising applying a composition of the present invention to said plant or plant part.

### INTRODUCTION

Copper-based fungicides are well-known but uses of copper-based fungicides are limited due to phytotoxicity to plant and toxicity to user.

The solubility of copper ions in water depends on the source of the copper ions. Copper-based fungicides such as cupric acetate, cupric chloride and cupric chlorate, cupric formate, cupric hexafluorosilicate, cupric nitrate, cupric chromate, copper and sulfate pentahydrate are highly soluble in water. Others such as copper hydroxide, copper oxychloride sulfate (COCS), and tribasic copper sulfate (cupric sulfate, tricupric hydroxide, hemihydrate), which are also known as “fixed” coppers, are relatively less soluble in water. The solubility in water affects the amount of the copper-based fungicide that may be applied and its level of toxicity.

The copper particles adhere to the leaf surface and act as ion reservoirs, continuously releasing Cu²⁺ ions and forming a protective layer which prevent infection. Copper fungicides formulations vary in efficiency of Cu²⁺ ion release which is dependent upon the copper source. Moreover, the concentration of copper ions on the leaves depends on the equilibrium established with the complexed and soluble forms of copper (Menkissoglu and Lindow 1991).

It is known that copper is toxic when the dissolved form penetrates plant tissue. In general, the use of spray additives such as foliar nutrients, and any surfactants with penetrating characteristics should be avoided when applying copper-based fungicides.

Suspension concentrate (SC) compositions containing copper sulphate pentahydrate and tannate complex of picro ammonium formate were disclosed in U.S. Pat. Nos. 4,544,666 and 4,673,687. These compositions contain picric acid which has many disadvantages. Picric acid is also known as an explosive compound that should be handled very carefully.

Polyelectrolytes are known in the agricultural field as slow release imparting agents. WO 2008/002623 describes the use of ion exchanging polymers to provide slow release of a charged pesticide.

Furthermore, WO 2013/133705 and WO 2013/133706 describe the use of a neutral, insoluble polyelectrolyte complex, generated by mixing solutions of a polycation and a polyanion.

PCT/IB2020/055089 discloses use of polycation for increasing biological effect of mancozeb.

US 2002/010099 discloses combinations of crop protection agents with anionic polymers.

There is a need to develop a composition with improved efficacy and reduced amount of the copper-based fungicide.

### SUMMARY OF THE INVENTION

The present invention provides a combination of copper-based fungicide and polyelectrolyte. In some embodiments, the combination is a macromolecular complex comprising the copper-based fungicide and the polyelectrolyte.

In some embodiments, the combination is (1) a macromolecular complex comprising the copper-based fungicide, the polyelectrolyte, and (2) an additional fungicide(s).

In some embodiments, the combination is (1) a macromolecular complex comprising the copper-based fungicide, the polyelectrolyte, and (2) at least two additional fungicides.

The present invention provides a composition comprising the combination described herein and at least one agriculturally acceptable additive.

In some embodiments, the composition comprises at least one additional fungicide.

The present invention provides a pesticidal delivery system comprising the combination or composition described herein.

The present invention provides a method of treating a plant, or a part of a plant, against a pathogen, comprising contacting the plant, or part of the plant, with an effective amount of any one of the combination, composition or delivery system described herein so as to thereby treat the plant or part of the plant against the pathogen.

The present invention provides a method of promoting growth of a crop plant in the presence of a pathogen comprising contacting the plant, or part of the plant, with an effective amount of any one of the combination, composition or delivery system described herein so as to thereby promote the growth of the crop plant treat than if the same type and amount of copper base fungicide is formulated in the absence of polyelectrolyte.

The present invention provides a method for improving efficacy of a copper-based fungicide comprising interacting the copper-based fungicide with a polyelectrolyte prior to application of the copper-based fungicide to a plant, a plant part, and/or soil.

The present invention provides a method for controlling the release rate of copper cation from a copper-based fungicide comprising interacting the copper-based fungicide with a polyelectrolyte prior to application of the copper-based fungicide to a plant, a plant part, and/or soil.

The present invention provides a method for (i) increasing biological activity of a copper-based fungicide on a target, (ii) increasing persistence of a copper-based fungicide into a target, (iii) increasing retention of a copper-based fungicide by a target, (iv) increasing absorbance of a copper-based fungicide by a target, or (v) increasing or enhancing bioavailability of a copper-based fungicide to a target, wherein the method comprises interacting the copper-based fungicide with a polyelectrolyte prior to application of the copper-based fungicide to a plant, a plant part, and/or soil.

The present invention provides a method for (i) reducing drift of a copper-based fungicide, (ii) increasing leaf adhesion of a copper-based fungicide, (iii) increasing rainfastness of a copper-based fungicide, (iv) increasing persistence of a copper-based fungicide, and/or (v) reducing phytotoxicity of a copper-based fungicide, wherein the method comprises interacting the copper-based fungicide with a polyelectrolyte prior to application of the copper-based fungicide.

The present invention provides a process for producing a macromolecular complex comprising a copper-based fungicide and a polyelectrolyte comprising the following steps:
(a) providing an aqueous composition of the polyelectrolyte,
(b) mixing the copper-based fungicide into the aqueous composition, and
(c) thereby producing the macromolecular complex of the polyelectrolyte and the copper-based fungicide in an aqueous composition.

The present invention provides a process for preparing the composition described herein comprising mixing the macromolecular complex with at least one agriculturally acceptable additive. LEGENDS TO THE FIGURES

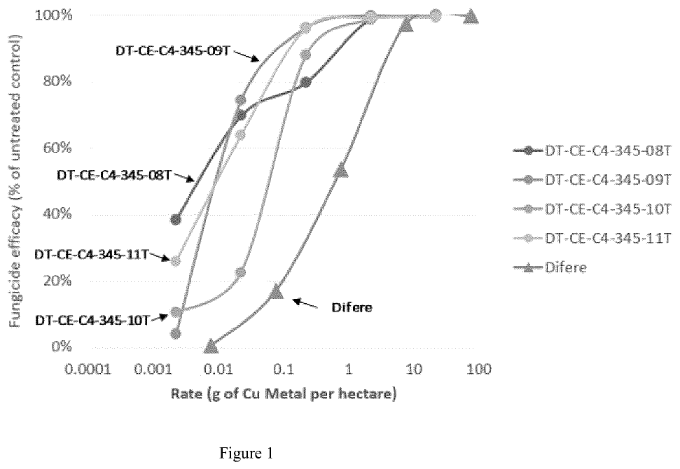

FIG. 1. Dose-response curves of the four new copper-fungicide prototype formulations, DT-CE-C4-345-08T ( [symbol] ), DT-CE-C4-345-09T ( [symbol] ), DT-CE-C4-345-10T ( [symbol] ), DT-CE-C4-345-11T ( [symbol] )+0.05% Tween 80 and copper oxychloride (Difere)+0.05% Tween 80 ( [symbol] ) towards Phakopsora pachyrhizi strain THAI1 obtained from the AUDPC.

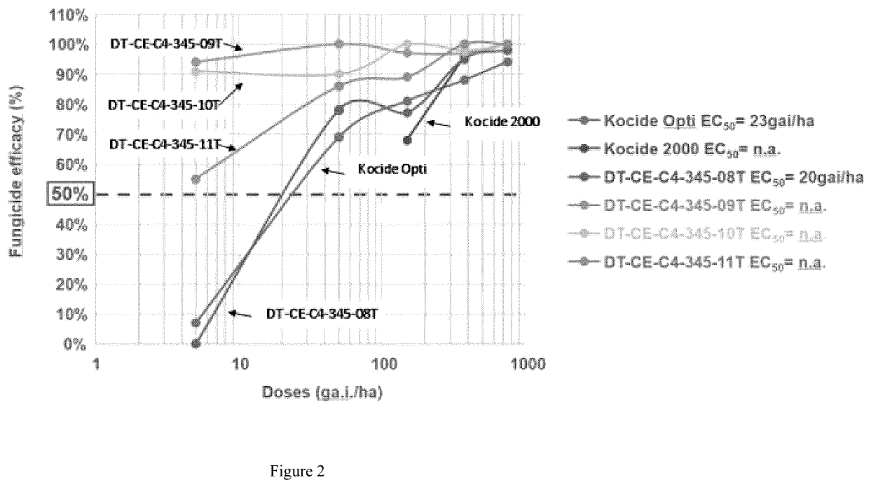

FIG. 2. In planta evaluations of the four new copper-fungicide prototype formulations, DT-CE-C4-345-08T ( [symbol] ), DT-CE-C4-345-09T ( [symbol] ), DT-CE-C4-345-10T ( [symbol] ) and DT-CE-C4-345-11T ( [symbol] ), Kocide Opti ( [symbol] ), and Kocide 2000 ( [symbol] ) towards Potato Late Blight caused by Phytophthora infestans. Dose Effect curves (Efficacy calculated via DSI value; %) representation at 7 dpi of Potato whole plant treated preventatively 24h before inoculation with P. infestans. A minimum of 12 leaves are considered for each condition. The EC₅₀ for each copper-based product are assessed.

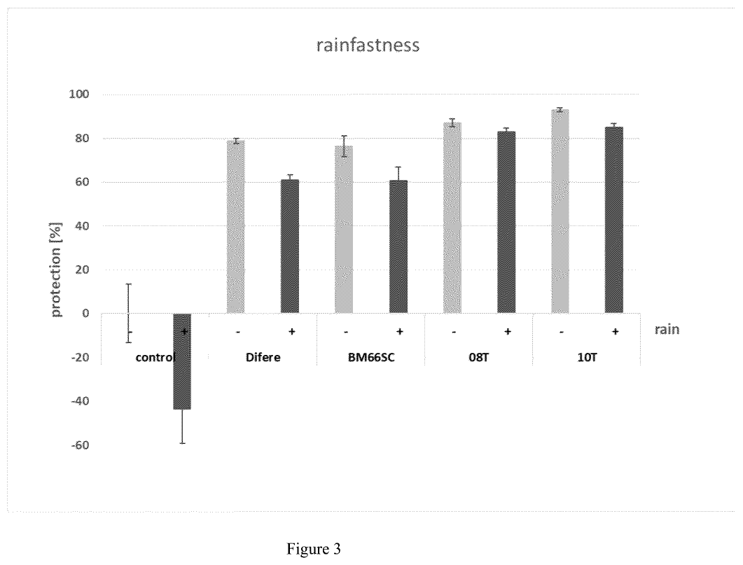

FIG. 3. Improved rainfastness of DT-CE-C4-345-08T and DT-CE-C4-345-10T in soybean compared to other copper formulations.

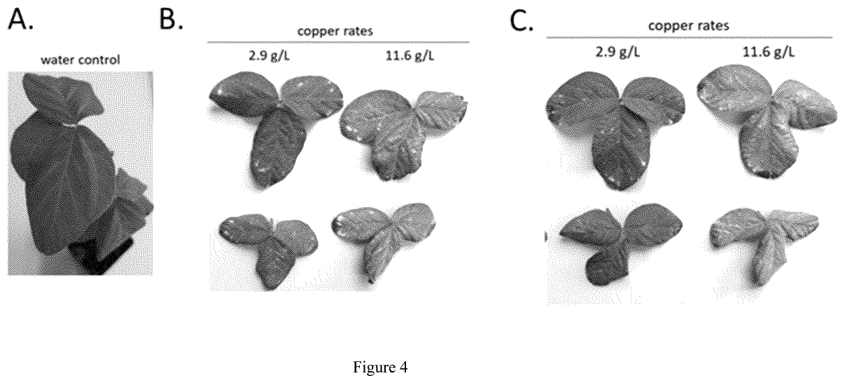

FIG. 4. No phytotoxicity of DT-CE-C4-345-08T and DT-CE-C4-345-10T towards Soybeans (Glycine max Abelina).

### DETAILED DESCRIPTION

### Definitions

Unless defined otherwise, all technical and scientific terms used herein have the meaning commonly understood by persons of ordinary skill in the art to which this subject matter pertains.

The term “a” or “an”, as used herein, includes the singular and the plural, unless specifically stated otherwise. Therefore, the terms “a,” “an,” or “at least one” can be used interchangeably in this application.

As used herein, the term “about” when used in connection with a numerical value includes 10% from the indicated value. In addition, all ranges directed to the same component or property herein are inclusive of the endpoints, are independently combinable, and include all intermediate points and ranges. It is understood that where a parameter range is provided, all integers within that range, and tenths thereof, are also provided by the invention. For example, “30-45%” includes 30%, 30.1%, 30.2%, etc. up to 45%.

The term “polyelectrolyte”, as is used herein, refers to a molecule consisting of a plurality of functional, charged groups that are linked to a polymer backbone. In the context of this application, the term “polycation” is interchangeable with the term “positively charged polyelectrolyte”, while the term “polyanion” is interchangeable with the term “negatively charged polyelectrolyte”. The terms polycation and polyanion refer to positively charged and negatively charged polymer molecules, respectively, under neutral or acidic conditions, i.e. at pH 3-8.

The term “polyelectrolyte complex”, as is used herein, refers to a structure, a complex of oppositely charge polyelectrolytes (a polyanion and a polycation) that is formed by interaction of at least one polycation with at least one polyanion. The complex is strong, but reversible electrostatic links, thus avoiding the use of covalent cross-linkers. Polyelectrolyte complexes are described, for example, in WO 2013/133705 and WO 2013/133706, the contents of each of which are hereby incorporated by reference.

The term “macromolecular complex”, as is used herein, refers to structure that is formed by non-covalent interaction of a copper-based fungicide with a polyelectrolyte, such as at least one polyanion or at least one polyelectrolyte complex. In such macromolecular complex, the non-covalent interactions are preferably electrostatic interactions. The macromolecular complex thus avoids the use of covalent cross-linkers and result in a matric like physical structure.

The term “electrostatic interaction” as is used herein, refers to electric force between any two charged molecules and/or dipole molecules. The term “electrostatic interactions” includes ionic interactions, hydrogen bonds, and van der Waals forces such as dipole-dipole interactions.

The term “crop”, as is used herein, include cereals such as wheat, barley, rye, oats, sorghum and millet, rice, cassava and maize, and crops that produce, for example, peanut, sugar beet, cotton, soya, oilseed rape, potato, tomato, peach and vegetables.

The term “part of a plant”, as is used herein, indicates a part of a plant including, but not limited to, pollen, ovule, leaf, root, flower, fruit, stem, bulb, corn, branch and seed. The term “'polyion” refers to a molecule consisting of a plurality of charged groups that are linked to a common backbone. In the context of this application, the term “polycation” is interchangeable with the term “positively charged polyelectrolyte” and the term “polyanion” is interchangeable with the term “negatively charged polyelectrolyte”.

The term “suspension concentrate”, as used herein, refers to a suspension of solid particles in a liquid intended for dilution with water prior to use. In some embodiments, suspension concentrate refers to an aqueous suspension concentrate.

The term “dispersion concentrate”, as used herein, refers to a dispersion of solid particles in a liquid intended for dilution with water prior to use.

The term “water dispersible granules”, as used herein, refers to a formulation in granule form which is dispersible in water forming a dispersion such as a suspension or solution.

The term “wettable powder”, as used herein, refers to a powder formulation intended to be mixed with water or another liquid prior to use.

The term “water slurriable powder”, as used herein, refers to a powder formulation that is made into a slurry in water prior to use.

Combination, macromolecular complex, and composition comprising copper-based fungicide, polyelectrolyte and additional fungicides.

It is an objective of the present invention to provide compositions and methods that allow reduction in the amounts of copper-based fungicide needed to control phytopathogenic pests. Another objective of the present invention is to develop methods and compositions which provide effective plant growth control. Plant growth control refers to preventing damage to the plant by controlling pathogen and reduction negative effect on the plant health.

It was surprisingly found that a combination of copper-based fungicide and polyelectrolyte may significantly reduce the amount of copper-based fungicide needed to achieve a given level of pest control and enhance biological efficacy and plant health. Improved biological efficacy includes improved uptake and bioavailability.

As used herein, the term “copper-based fungicide” refers to copper salt (such as copper sulfate, copper hydroxychloride, and copper oxide) and/or metallic copper.

As used herein, the term “metallic copper” refers to Cu²⁺ cation.

In some embodiments, the copper-based fungicide may be but not limited to cupric acetate, cupric chloride, cupric chlorate, cupric formate, cupric hexafluorosilicate, cupric nitrate, cupric chromate, copper sulfate pentahydrate, bordeaux mixture, copper hydroxide, copper oxychloride sulfate (COCS), tribasic copper sulfate such as cupric sulfate, tricupric hydroxide, hemihydrate, or any combination thereof.

In some embodiments, the copper-based fungicide is selected from the group consisting of cupric acetate, cupric chloride, cupric chlorate, cupric formate, cupric hexafluorosilicate, cupric nitrate, cupric chromate, copper sulfate pentahydrate, Bordeaux mixture and any combination thereof.

In some embodiments, the copper-based fungicide is selected from the group consisting of copper sulfate pentahydrate, Bordeaux mixture and any combination thereof. Copper-based fungicide and polyelectrolyte can be the constituents of a macromolecular complex which significantly decreases the amount of the copper-based fungicide needed to achieve a certain level of biological efficacy, enhances the biological efficacy of a given amount of copper-based fungicide, improves persistence of the copper-based fungicide, and reduces phytotoxicity of the copper-based fungicide, when compared to copper-based fungicide applied in the absence of polyelectrolyte.

In addition, a macromolecular complex according to the invention reduces drift of the copper-based fungicide. Said macromolecular complex surprisingly results in a reduction of the mobility of copper-based fungicide in the soil or leakage. Said complex furthermore results in reduced toxicity to the plants, hence causing less phytotoxicity, when compared to copper-based fungicide that is not applied as part of a macromolecular complex as described in the present invention.

The copper-based fungicide composition according to the present invention also has improved physical properties such as viscosity, different morphology and particle size when compared to a composition of free copper-based fungicide without polyelectrolyte.

The present innovative combination increases the solubility and/or dispersability of a copper-based fungicide and improves its biological efficacy by controlling the formation and release of the active component as copper ions. The net effect is that less copper-based fungicide is required to achieve control of agricultural pests, when compared to the same copper-based fungicide that is not formulated with polyelectrolytes.

The present invention provides a combination of copper-based fungicide and polyelectrolyte. The present invention provides a combination of copper-based fungicide and polyanion. The present invention provides a combination of an amount of copper-based fungicide and an amount of polyelectrolyte.

In some embodiments, the combination is a macromolecular complex comprising the copper-based fungicide and the polyelectrolyte.

In some embodiments, the combination is (1) a macromolecular complex comprising the copper-based fungicide, the polyelectrolyte and (2) additional fungicides.

In some embodiments, the macromolecular complex is characterized by intermolecular, non-covalent interactions, preferably electrostatic interactions such as ionic interactions, hydrogen bonds and van der Waals forces, such as dipole-dipole interactions, between the polyelectrolyte and the copper-based fungicide. In some embodiments, the copper-based fungicide molecules interact chemically with the polyelectrolyte through intermolecular force(s).

The present invention provides a macromolecular complex of a copper-based fungicide and a polyelectrolyte, wherein the macromolecular complex is characterized by intermolecular, non-covalent interactions, preferably electrostatic interactions such as ionic interactions, hydrogen bonds and van der Waals forces, such as dipole-dipole interactions, between the polyelectrolyte and the copper-based fungicide.

The present invention provides a composition comprising (1) a copper-based fungicide, (2) a polyelectrolyte, and (3) at least one agriculturally acceptable additive. The present invention provides a composition comprising (1) an amount of copper-based fungicide, (2) an amount of a polyelectrolyte, and (3) at least one agriculturally acceptable additive.

In some embodiments, the present invention provides a composition comprising (1) a copper-based fungicide, (2) a polyelectrolyte, (3) at least one additional fungicide, and (4) at least one agriculturally acceptable additive.

The present invention provides a composition comprising (1) an amount of copper-based fungicide, (2) an amount of a polyelectrolyte, (3) at least one additional fungicide, and (4) at least one agriculturally acceptable additive.

In some embodiments, the composition comprises a macromolecular complex of the copper-based fungicide and the polyelectrolyte.

The present invention provides a composition comprising macromolecular complex comprising copper-based fungicide and polyelectrolyte. The present invention provides a composition comprising (i) macromolecular complex comprising copper-based fungicide and polyelectrolyte, and (ii) at least one agriculturally acceptable additive.

The present invention provides a composition comprising (i) a macromolecular complex comprising a copper-based fungicide and a polyelectrolyte and (ii) at least one additional fungicide.

The present invention provides a composition comprising (i) a macromolecular complex comprising a copper-based fungicide and a polyelectrolyte, (ii) at least one additional fungicide and (iii) at least one agriculturally acceptable additive.

The present invention provides a composition comprising a copper-based fungicide and a polyelectrolyte.

The present invention provides a composition comprising (i) a copper-based fungicide (ii) a polyelectrolyte, (iii) at least one additional fungicide, and (iv) at least one agriculturally acceptable additive.

In some embodiments, the polyelectrolyte comprises at least one polyanion. In some embodiments, the polyelectrolyte is a polyanion. In some embodiments, the polyelectrolyte comprises a polycation and a polyanion. In some embodiments, the polyelectrolyte is a complex of a polycation and a polyanion. The present invention provides a composition comprising any one of the combinations or macromolecular complexes described herein and at least one acceptable additive.

In some embodiments, the agriculturally acceptable additive is an agriculturally acceptable carrier.

In some embodiments, the agriculturally acceptable carrier is water.

In some embodiments, the copper-based fungicide is suspended in the water.

In some embodiments, the additional fungicide(s) is/are suspended in the water.

In some embodiments, the composition comprises at least two additional fungicides which are suspended in a water carrier.

In some embodiments, the composition further comprises an organic phase.

In some embodiments, the composition comprises an organic phase which comprises a water-immiscible carrier.

In some embodiments, the organic phase is oil-organic solvent drops in water.

In some embodiments, the composition comprises at least one additional fungicide which is dissolved in a water-immiscible carrier.

In some embodiments, the composition comprises at least one additional fungicide which is suspended in a water carrier.

In some embodiments, the composition comprises at least two additional fungicides which are dissolved in the water-immiscible carrier.

In some embodiments, the composition comprises at least two additional fungicides wherein one is dissolved in a water-immiscible carrier and the other is suspended in the water carrier.

In some embodiments, the composition has viscosity in the range of 1500-1800 cPs (measured with a Brookfield spindle 63 at 12 rpm).

In some embodiments, the composition comprises particles with a particle size distribution (d90) is 10 microns or less. In some embodiments, the composition comprises particles with a particle size distribution (d90) is 7 microns or less. In some embodiments, the composition comprises particles with a particle size distribution (d90) of 4 microns or less.

In some embodiments, the composition has a pH in the range of 5.0-7.5.

In some embodiments, the composition has a density (g/ml) of 1.26±0.05 at 25° C.

A composition according to the invention preferably is in the form of a suspension concentrate (SC), a water dispersible granule (WG), a wettable powder (WP), a dispersion concentrate (DC), a dry powder seed treatment (DS), a water slurriable powder (WS), or a flowable seed treatment (FS), or a suspo-emulsion (SE). Preferably, a composition of the invention is in the form of a suspension concentrate, or in the form of water dispersible granules. A most preferred composition is a suspension concentrate or SE. In embodiments, the SE is a dispersion of solid particles and oil-organic solvent drops in water intended for dilution with water prior to use.

In some embodiments, the copper-based fungicide is suspended in water. In some embodiments, the additional fungicide(s) can be suspended and/or dissolved in a water-immiscible carrier

In some embodiments, the polyelectrolyte comprises at least one polyanion. In some embodiments, the polyelectrolyte is a polyanion. In some embodiments, the polyelectrolyte comprises a polycation and a polyanion. In some embodiments, the polyelectrolyte is a complex of polycation and polyanion.

In some embodiments, the weight ratio between the polyelectrolyte and the metallic copper in the copper-based fungicide in the combination and/or composition is between 1:10 to 1:1. In some embodiments, the weight ratio between the polyelectrolyte and the metallic copper in the copper-based fungicide in the combination and/or composition is between 1:1 and 1:7. In some embodiments, the weight ratio between the polyelectrolyte and the metallic copper in the copper-based fungicide in the combination and/or composition is between 1:1 and 1:5. In some embodiments, the weight ratio between the polyelectrolyte and the metallic copper in the copper-based fungicide in the combination and/or composition is between 1:3 and 1:5. In some embodiments, the weight ratio between the polyelectrolyte and the metallic copper in the copper-based fungicide in the combination and/or composition is 1:3.5. In some embodiments, the weight ratio between the polyelectrolyte and the metallic copper in the copper-based fungicide in the combination and/or composition is 1:4.4. In some embodiments, the weight ratio between the polyelectrolyte and the metallic copper in the copper-based fungicide in the combination and/or composition is between 1:10 to 1:1, more preferred in a ratio between 1:10 and 1:5, and more preferred at a ratio of 1:3.5.

In some embodiments, the polyelectrolyte comprises polycation and polyanion and the weight ratio between the polyelectrolyte and the metallic copper in the copper-based fungicide in the combination and/or composition described herein is in the range of 1:1 to 1:10.

In some embodiments, the polyelectrolyte comprises a polycation and a polyanion and the weight ratio between the polyelectrolyte and the metallic copper in the copper-based fungicide in the combination and/or composition described herein is 1:3.5.

In some embodiments, the polyelectrolyte comprises polyanion and the weight ratio between the polyelectrolyte and the metallic copper in the copper-based fungicide in the combination and/or composition described herein is 1:4.4.

In some embodiments, the polyelectrolyte comprises a polycation and a polyanion and the weight ratio between the polycation and polyanion is 1:5.

In some embodiments, the polyelectrolyte comprises a polycation and a polyanion and the weight ratio between the polycation and polyanion is 1:9.

In some embodiments, the polyelectrolyte and the copper has neutral zeta potential. In some embodiments, neutral zeta potential refers to ±5 Mv. In some embodiments, the zeta potential is measured in absence of additional acceptable agricultural additives.

In some embodiments, the copper-based fungicide interacts with the polyelectrolyte by intermolecular, non-covalent interactions, preferably electrostatic interactions such as ionic interactions, hydrogen bonds and van der Waals forces, such as dipole-dipole interactions, between the polycation and the copper-based fungicide.

In some embodiments, the macromolecular complex is characterized by non-covalent intermolecular interactions, preferably ionic interaction and hydrogen bonds between donor and acceptor groups of the polycation and the copper-based fungicide.

In some embodiments, the copper-based fungicide and polyelectrolyte are interacted by non-covalent intermolecular interactions, preferably ionic interaction and hydrogen bonds between donor and acceptor groups of the polycation and the copper-based fungicide.

In some embodiments, the combination, macromolecular complex, and/or composition comprises more than 1 part of polyanion per 3 to 5 parts of the metallic copper-based fungicide by weight. In some embodiments, the combination, macromolecular complex, and/or composition comprises more than 1 part of polyanion per 3 parts of the metallic copper-based fungicide by weight. In some embodiments, the combination, macromolecular complex, and/or composition comprises more than 1 part of polyanion per 4 parts of the metallic copper-based fungicide by weight. In some embodiments, the combination, macromolecular complex, and/or composition comprises more than 1 part of polyanion per 5 parts of the metallic copper-based fungicide by weight.

In some embodiments, the batch of copper-based fungicide is a mixture of the copper-based fungicide and at least one additive. In some embodiments, the batch of copper-based fungicide is a mixture of the copper-based fungicide and a stabilizer. In some embodiments, the stabilizer is a polyanion. In some embodiments, the additive is a polyanion.

The concentration of a polyelectrolyte in the combination or composition according to the invention is preferably between 0.1 and 50 g/kg. In some embodiments, the concentration of the polyelectrolyte in the combination or composition is between 0.1 and 50 g/kg.

The concentration of the polyelectrolyte in the combination or composition according to the invention is preferably 0.01-5% by weight based on the total weight of the combination or composition, more preferably 0.1-4% by weight based on the total weight of the combination or composition, such as 2-3% by weight based on the total weight of the combination or composition. In some embodiments, the concentration of the polyelectrolyte in the combination or composition is 0.01-10% by weight based on the total weight of the combination or composition. In some embodiments, the concentration of the polyelectrolyte in the combination or composition is 0.1-5% by weight based on the total weight of the combination or composition. In some embodiments, the concentration of the polyelectrolyte in the combination or composition is 0.1-4% by weight based on the total weight of the combination or composition. In some embodiments, the concentration of the polyelectrolyte in the combination or composition is 0.1-3% by weight based on the total weight of the combination or composition. In some embodiments, the concentration of the polyelectrolyte in the combination or composition is about 2-3% by weight based on the total weight of the combination or composition. In some embodiments, the concentration of the polyelectrolyte in the combination or composition is about 3% by weight based on the total weight of the combination or composition. In some embodiments, the concentration of the polyelectrolyte in the combination or composition is 2.3% by weight based on the total weight of the combination or composition. In some embodiments, the concentration of the polyelectrolyte in the combination or composition is 2.8% by weight based on the total weight of the combination or composition.

In some embodiments, the polycation is chitosan. In some embodiments, the polyanion is lignosulfonate. In some embodiments, the lignosulfonate is calcium lignosulfonate.

In some embodiments, the concentration of calcium lignosulfonate in the composition is between 2% to 3% by weight based on the total weight of the composition. In some embodiments, the concentration of calcium lignosulfonate in the composition is about 2.3% by weight based on the total weight of the composition.

In some embodiments, the concentration of chitosan in the composition is between 0.1% to 1% by weight based on the total weight of the composition. In some embodiments, the concentration of chitosan in the composition is about 0.5% by weight based on the total weight of the composition.

In some embodiments, the composition is substantially free or free of polycation. In some embodiments, the macromolecular complex is substantially free or free of polycation. In some embodiments, the composition is substantially free or free of chitosan. In some embodiments, macromolecular complex is substantially free or free of chitosan.

As used herein, “substantially free” refers to a concentration less than 0.1% w/w, preferably less than 0.05% w/w, more preferably less than 0.01% w/w.

In some embodiments, the composition comprises a polyanion and a polycation. In some embodiments, the macromolecular complex comprises a polyanion and a polycation. In some embodiments, the polyelectrolyte comprises a polyanion and a polycation. In some embodiments, the composition comprises lignosulfonate and chitosan. In some embodiments, the macromolecular complex comprises lignosulfonate and chitosan. In some embodiments, the polyelectrolyte is a complex of lignosulfonate and chitosan.

In some embodiments, the combined weight of lignosulfonate and chitosan in the composition is between 1% to 10% by weight based on the total weight of the composition. In some embodiments, the combined weight of lignosulfonate and chitosan in the composition is between 1% to 5% by weight based on the total weight of the composition. In some embodiments, the combined weight of lignosulfonate and chitosan in the composition is between 2% to 3% by weight based on the total weight of the composition. In some embodiments, the combined weight of lignosulfonate and chitosan in the composition is 2.8% by weight based on the total weight of the composition.

In some embodiments, the copper-based fungicide is added to the composition in the form of a formulation.

In some embodiments, the concentration of the copper-based fungicide is up to 25% by weight based on the total weight of the composition. In some embodiments, the concentration of the copper-based fungicide is up to 10% by weight based on the total weight of the composition. In some embodiments, the concentration of the copper-based fungicide in the composition is between 100 and 250 g/L. In some embodiments, the concentration of the copper-based fungicide in the composition is 110 g/L.

In some embodiments, the concentration of the copper-based fungicide is more than 25% by weight based on the total weight of the composition. In some embodiments, the concentration of the copper-based fungicide is more than 25% by weight based on the total weight of the composition. In some embodiments, the concentration of the copper-based fungicide in the composition is more than 30% by weight based on the total weight of the composition.

In some embodiments, the concentration of the metallic copper in the formulation comprising the copper-based fungicide is between 10 g/L to 250 g/L. In some embodiments, the concentration of the metallic copper in the formulation comprising the copper-based fungicide is between 50 g/L to 150 g/L. In some embodiments, the concentration of the metallic copper in the formulation comprising the copper-based fungicide is 100 g/L.

In some embodiments, the concentration of the metallic copper in the formulation comprising the copper-based fungicide is 1-25% by weight based on the total weight of the formulation. In some embodiments, the concentration of the metallic copper in the formulation comprising the copper-based fungicide is 5-25% by weight based on the total weight of the formulation. In some embodiments, the concentration of the metallic copper in the formulation comprising the copper-based fungicide is 5-15% by weight based on the total weight of the formulation. In some embodiments, the concentration of the metallic copper in the formulation comprising the copper-based fungicide is about 10% by weight based on the total weight of the formulation. In some embodiments, the concentration of the metallic copper in the formulation comprising the copper-based fungicide is 10.1% by weight based on the total weight of the formulation.

In some embodiments, the concentration of the metallic copper in the formulation comprising the copper-based fungicide is up to 25% by weight based on the total weight of the formulation. In some embodiments, the concentration of the metallic copper in the formulation comprising the copper-based fungicide is 10% by weight based on the total weight of the formulation.

In some embodiments, the concentration of the metallic copper in the formulation comprising the copper-based fungicide is between 100 and 250 g/L, preferably 110 g/L. In some embodiments, the concentration of copper-based fungicide in the formulation is between 15% to 45% by weight based on the total weight of the formulation. In some embodiments, the concentration of copper-based fungicide in the formulation is between 20% to 35% by weight based on the total weight of the formulation. In some embodiments, the concentration of copper-based fungicide in the formulation is between 25% to 30% by weight based on the total weight of the formulation. In some embodiments, the concentration of copper-based fungicide in the formulation is 28.8% by weight based on the total weight of the formulation.

In some embodiments, the concentration of the formulation comprising the copper-based fungicide in the composition is between 150 and 500 g/L. In some embodiments, the concentration of the formulation comprising the copper-based fungicide in the composition is between 300 g/L to 400 g/L. In some embodiments, the concentration of the formulation comprising the copper-based fungicide in the composition is 345 g/L.

In some embodiments, the concentration of the metallic copper in the composition is 0.1% to 10% by weight based on the total weight of the composition. In some embodiments, the concentration of the metallic copper in the composition is 0.5% to 5% by weight based on the total weight of the composition. In some embodiments, the concentration of the metallic copper in the composition is 2% to 3% by weight based on the total weight of the composition. In some embodiments, the concentration of the metallic copper in the composition is 2.9% by weight based on the total weight of the composition.

In some embodiments, the copper-based fungicide is copper sulfate. In some embodiments, the copper-based fungicide is copper oxychloride. In some embodiments, the copper-based fungicide is copper hydroxide.

The addition of an additive affects the chemically and physically stability of the compositions. Said additives may, for example, improve the stability of the composition.

In some embodiments, the agriculturally acceptable additive is selected from agriculturally acceptable carriers, buffers, acidifiers, antifoaming agents, anti-freeze agents, solvents, co-solvents, stabilizers, light stabilizers, UV absorbers, radical scavengers and antioxidants, adhesives, neutralizers, thickeners, binders, sequestrates, biocides, drift retardants, surfactants, dispersants, pigments, wetting agents, safeners, and preservatives. Said additives include, but are not limited to, surfactants, pigments, wetting agents, as well as safeners, or such preservatives as bacteriostats or bactericides.

In some embodiments, the agriculturally acceptable additive is an agriculturally acceptable carrier. In some embodiments, the composition comprises at least one agriculturally acceptable carrier.

The addition of small amounts of one or more agriculturally acceptable additives may affect parameters such as stability, efficacy and/or rainfastness of a composition according to the invention. The addition of small amounts of one or more agriculturally acceptable carriers preferably increases stability, efficacy and/or rainfastness of a composition according to the invention.

In some embodiments, the agriculturally acceptable carrier is water.

In some embodiments, the composition comprises 40-80% by weight of water. In some embodiments, the composition comprises 50-70% by weight of water. In some embodiments, the composition comprises 50-55% by weight of water. In some embodiments, the composition comprises about 52% by weight of water. In some embodiments, the composition comprises about 53% by weight of water. In some embodiments, the composition comprises about 54% by weight of water. In some embodiments, the composition comprises about 55% by weight of water.

In some embodiments, the composition is an aqueous composition.

The present invention also provides an aqueous composition comprising any one or any combination of the combination and/or macromolecular complexes described herein, water and agriculturally acceptable additive.

In some embodiments, the concentration of the metallic copper in the copper-based fungicide in the aqueous composition is 10.1% by weight based on the total weight of the composition and the composition further comprises a stabilizer.

In some embodiments, the additive refers to surfactant.

In some embodiments, the surfactant is a wetting agent, dispersant, or a combination thereof.

In some embodiments, the dispersant is an anionic polymeric surfactant such as Metasperse 500L.

In some embodiments, the dispersant is an anionic surfactant such as Tensiofix LB350.

In some embodiments, the dispersant is a nonionic surfactant such as Tensiofix L051. In some embodiments, the dispersant is an anionic surfactant such as ECOSURF™ EH-6. In some embodiments, the dispersant is an anionic tristyrylphenol phosphate surfactant such as Soprophor FL or Soprophor® 3 D 33. In some embodiments, the dispersant is a nonionic surfactant such as TERGITOL™ XD. In some embodiments, the dispersant is a nonionic surfactant such as Atlox™ 4913.

In some embodiments, the dispersant is a mixture of anionic and nonionic surfactants such as Tensiofix CGA213.

In some embodiments, the wetting agent is a high HLB polymeric wetting agent such as Atlas G65002L.

In some embodiments, high HLB is more than 10. In some embodiments, high HLB is more than 12. In some embodiments, high HLB is more than 13. In some embodiments, high HLB is more than 14.

In some embodiments, the high HLB of the nonionic polyalkylene oxide block polymer surfactant is more than 10. In some embodiments, the high HLB of the nonionic polyalkylene oxide block polymer surfactant is more than 12. In some embodiments, the high HLB of the nonionic polyalkylene oxide block polymer surfactant is more than 13. In some embodiments, the high HLB of the nonionic polyalkylene oxide block polymer surfactant is more than 14.

In some embodiments the wetting agent is Adsee 900 a decyl alcohol ethoxylate.

In some embodiments, the composition further comprises a stabilizer.

In some embodiments, the concentration of the metallic copper in the copper-based fungicide in the aqueous composition is more than 10% by weight based on the total weight of the composition, the dispersant is the anionic polymeric surfactant Metasperse 500L, the anionic surfactant Tensiofix LB350, the anionic surfactant ECOSURF™ EH-6, the anionic tristyrylphenol phosphate surfactant Soprophor FL or Soprophor® 3 D 33, the nonionic surfactant such as TERGITOL™ XD, the nonionic surfactant Atlox™ 4913, or the nonionic surfactant Tensiofix L051. The wetting agent is the high HLB polymeric wetting agent Atlas G65002L, and the composition further comprises a stabilizer.

In some embodiments, the concentration of metallic copper in the copper-based fungicide in the aqueous composition is more than 10% by weight based on the total weight of the composition, the surfactant is a combination of anionic and nonionic surfactants like Tensiofix CGA213 or TERGITOL™ XD.

The present invention also provides an aqueous composition comprising (1) macromolecular complex comprising (i) a copper-based fungicide and (ii) a polyelectrolyte, (2) water, and (3) at least one agriculturally acceptable additive, wherein (i) the viscosity is in the range of 1500-1800 cPs (measured with a Brookfield spindle 63 at 12 rpm), (ii) the particle size distribution (d90) is below 4 microns, (iii) the pH in the range of 5.0-7.5, and/or (iv) the density (g/ml) at 25° C. is 1.26±0.05.

In some embodiments, the viscosity is measured with a Brookfield spindle 63 at 12 rpm.

In some embodiments, the viscosity in the composition is in the range of 1500-1800 cPs (measured with a Brookfield spindle 63 at 12 rpm).

In some embodiments, the particle size distribution (d90) in the composition is below 10 microns and the particle size distribution (d50) is below 5 microns.

In some embodiments, the pH in the composition is in the range of 5.0-7.5.

In some embodiments, the density (g/ml) of the composition at 25° C. is 1.26±0.05.

In some embodiments, the agriculturally acceptable additive is a dispersant. In some embodiments, the composition comprises at least one dispersant.

In some embodiments the composition comprising at least one anionic dispersant and at least one non-ionic surfactant.

A composition of the invention may also comprise two or more different dispersants. A dispersant is preferably present in an amount of between 0 to up to 10% (w/v), more preferred between 0.01 to up to 5% (w/v), more preferred between 0.02 to up to 2% (w/v),

In some embodiments, the dispersant is a modified acrylic polymer, non-modified acrylic acid or any combination thereof.

In some embodiments, the modified acrylic polymer is modified styrene acrylic acid, polymethyl methacrylate-polyethylene glycol graft copolymer or any combination thereof. In some embodiments, modified acrylic polymer is modified styrene acrylic polymer. In some embodiments, the modified styrene acrylic polymer is Atlox Metasperse™ 500L (sold by Croda). In some embodiments, the modified acrylic polymer is polymethyl methacrylate-polyethylene glycol graft copolymer.

In some embodiments, the concentration of the dispersant in the composition is 0.01-15% by weight based on the total weight of the composition.

In some embodiments, the concentration of the dispersant in the composition is 0.01-12% by weight based on the total weight of the composition. In some embodiments, the concentration of the dispersant in the composition is 1-12% by weight based on the total weight of the composition. In some embodiments, the concentration of the dispersant in the composition is 0.01-10% by weight based on the total weight of the composition. In some embodiments, the concentration of the dispersant in the composition is 1-5% by weight based on the total weight of the composition. In some embodiments, the concentration of the dispersant in the composition is 5-10% by weight based on the total weight of the composition. In some embodiments, the concentration of the dispersant is about 2% by weight based on the total weight of the composition. In some embodiments, the concentration of the dispersant is about 5% by weight based on the total weight of the composition. In some embodiments, the concentration of the dispersant is about 6% by weight based on the total weight of the composition. In some embodiments, the concentration of the dispersant is about 7% by weight based on the total weight of the composition. In some embodiments, the concentration of the dispersant is about 8% by weight based on the total weight of the composition. In some embodiments, the concentration of the dispersant is about 9% by weight based on the total weight of the composition. In some embodiments, the concentration of the dispersant is about 10% by weight based on the total weight of the composition.

A composition according to the invention may further comprise at least one pH adjuster or buffering agent such as organic or inorganic bases and/or organic or inorganic acids.

In some embodiments, the composition comprises one or more physical stabilizers such as buffers, acidifiers, defoaming agents, thickeners and drift retardants.

In some embodiments, the composition comprises at least one stabilizer. In some embodiments, the agriculturally acceptable additive is a stabilizer.

When polyelectrolyte is complex of polyanion and polycation, a stabilizer, may be used. A stabilizer, when present, is preferably selected from carboxylic acids such as citric acid, acetic acid, and/or dodecylbenzensulfonic acid, orthophosphoric acid dodecylbenzensulfonic acid and suitable salts thereof. A composition of the invention may also comprise two or more different stabilizers. A stabilizer is preferably present in an amount of between 0 to up to 10% (w/v), more preferred between 0.01 to up to % (w/v), more preferred between 0.02 to up to 1% (w/v), more preferred about 0.05% (w/v).

In some embodiments, the stabilizer is an acid. In some embodiments, the acid is acetic acid. Acids are used to obtains dissolution of some polyelectrolyte. For example, chitosan is an aminoglycan consisting of beta-(1right4)-linked D-glucosamine residues. In acidic environment, global protonation of the 2-amino groups creates cationic chitosan.

In some embodiments, the concentration of the acid in the composition is 0-5% by weight based on the total weight of the composition. In some embodiments, the concentration of the acid in the composition is 0.01-5% by weight based on the total weight of the composition. In some embodiments, the concentration of the acid in the composition is 0.1-0.5% by weight based on the total weight of the composition. In some embodiments, the concentration of the acid in the composition is about 0.3% by weight based on the total weight of the composition. In some embodiments, the concentration of the acid in the composition is 1-3% by weight based on the total weight of the composition. In some embodiments, the concentration of the acid in the composition is 1.5-2% by weight based on the total weight of the composition. In some embodiments, the composition comprises at least one anti-foam agent. In some embodiments, the agriculturally acceptable additive is an anti-foam agent.

In some embodiments, the composition comprises at least one anti-foaming agent. In some embodiments, the agriculturally acceptable additive is an anti-foaming agent. An anti-foam agent, when present, is preferably selected from polymethylsiloxane, polydimethylsiloxane, simethicone octanol, and silicone oils. A composition of the invention may also comprise two or more different anti-foam agents. An anti-foam agent is preferably present in an amount of between 0 to up to 10% (w/v), more preferred between 0.05 to up to 5% (w/v), more preferred between 0.1 to up to 1% (w/v), more preferred about 0.05% (w/v).

In some embodiments, the anti-foam agent is silicone-based.

In some embodiments, the concentration of the anti-foam forming agent is 0.01-5% by weight based on the total weight of the composition. In some embodiments, the concentration of the anti-foam forming agent is 0.1-1% by weight based on the total weight of the composition. In some embodiments, the concentration of the anti-foam forming agent is about 0.4% by weight based on the total weight of the composition. In some embodiments, the concentration of the anti-foam forming agent is about 0.5% by weight based on the total weight of the composition.

In some embodiments, the composition comprises at least one antifreezing agent. In some embodiments, the agriculturally acceptable additive is an antifreezing agent.

An antifreezing agent (or “antifreeze”), when present, is preferably selected from glycerine, ethylene glycol, hexyleneglycol and propylene glycol. A composition of the invention may also comprise two or more different antifreezing agents. An antifreezing agent is preferably present in an amount of between 0 to up to 10% (w/v), more preferred between 0.01 to up to 5% (w/v), more preferred between 0.02 to up to 1% (w/v), more preferred about 0.05% (w/v).

In some embodiments, the antifreezing agent is propylene glycol.

In some embodiments, the concentration of the antifreezing agent in the composition is 1-10% by weight based on the total weight of the composition. In some embodiments, the concentration of the antifreezing agent in the composition is 1-5% by weight based on the total weight of the composition. In some embodiments, the concentration of the antifreezing agent in the composition is about 4% by weight based on the total weight of the composition. In some embodiments, the concentration of the antifreezing agent in the composition is about 5% by weight based on the total weight of the composition. In some embodiments, the concentration of the antifreezing agent in the composition is 4.2% by weight based on the total weight of the composition.

In some embodiments, the composition comprises at least one surfactant. In some embodiments, the agriculturally acceptable additive is a surfactant.

Surfactants may include but are not limited to ionic or non-ionic surface active agents. Examples of surfactants are alkyl-end-capped ethoxylate glycol, alkyl-end-capped alkyl block alkoxylate glycol, dialkyl sulfosuccinate, phosphated esters, alkyl sulfonates, alkyl aryl sulfonates, tristyrylphenol alkoxylates, natural or synthetic fatty acid alkoxylates, natural or synthetic fatty alcohols alkoxylates, alkoxylated alcohols (such as n-butyl alcohol poly glycol ether), block copolymers (such as ethylene oxide-propylene oxide block copolymers and ethylene oxide-butylene oxide block copolymers) or combinations thereof.

Examples of surfactants include but is not limited to emulsifiers and wetting agents.

In some embodiments, the surfactant is a non-ionic surfactant. In some embodiments, the non-ionic surfactant is Tensiofix L051. In some embodiments, the concentration of non-ionic surfactant in the composition is between 0.1% to 0.5% by weight based on the total weight of the composition. In some embodiments, the concentration of non-ionic surfactant in the composition is about 0.2% by weight based on the total weight of the composition.

In some embodiments, the surfactant is an anionic surfactant. In some embodiments, the anionic surfactant is Tensiofix LB350. In some embodiments the anionic surfactant is a tristyrylphenol phosphate surfactant. In some embodiments the tristyrylphenol phosphate surfactant is Soprophor FL or Soprophor® 3 D 33. In some embodiments, the concentration of anionic surfactant in the composition is between 1% to 3% by weight based on the total weight of the composition. In some embodiments, the concentration of anionic surfactant in the composition is about 2% by weight based on the total weight of the composition.

In some embodiments, the surfactant is a combination of anionic and non-ionic surfactants. In some embodiments, the surfactant is Tensiofix CGA213. In some embodiments, the concentration of the surfactant containing a combination of anionic and non-ionic surfactants in the composition is between 0.1% to 2% by weight based on the total weight of the composition. In some embodiments, the concentration of the surfactant containing a combination of anionic and non-ionic surfactants in the composition is about 1% by weight based on the total weight of the composition.

In some embodiments, the concentration of the surfactant in the composition is 0-0.5% by weight based on the total weight of the composition. In some embodiments, the concentration of the surfactant in the composition is 0.001-0.5% by weight based on the total weight of the composition. In some embodiments, the concentration of the surfactant in the composition is 0.01-1% by weight based on the total weight of the composition. In some embodiments, the concentration of the surfactant in the composition is about 0.1% by weight based on the total weight of the composition.

In some embodiments, the surfactant is a non-ionic hydrocarbon-based surfactant.

In some embodiments, the concentration of the non-ionic hydrocarbon-based surfactant in the composition is 0.001-0.5% by weight based on the total weight of the composition. In some embodiments, the concentration of the non-ionic hydrocarbon-based surfactant in the composition is about 0.1% by weight based on the total weight of the composition. In some embodiments, the concentration of the non-ionic hydrocarbon-based surfactant in the composition is 0.001-0.1% by weight based on the total weight of the composition.

In some embodiments, the total concentration of the surfactant(s) in the composition is 2-5% w/w by weight based on the total weight of the total composition. In some embodiments, the total concentration of the surfactant(s) in the composition is 3-4% w/w by weight based on the total weight of the total composition. In some embodiments, the total concentration of the surfactant(s) in the composition is about 3.2% w/w by weight based on the total weight of the total composition.

In some embodiments, when the polyelectrolyte is a complex with chitosan, the composition further comprises a co-solvent. In some embodiments, the co-solvent is an antifreeze agent. In some embodiments, the co-solvent is propylene glycol. In some embodiments, the antifreeze agent is propylene glycol.

In some embodiments, wherein the composition comprises at least one wetting agent. In some embodiments, the agriculturally acceptable additive is a wetting agent.

Wetting agent can be selected from di-octylsuccinate, polyoxyethylene/polypropylene, a decyl alcohol ethoxylate and tri-stearyl sulphonate/phosphate. A composition of the invention may also comprise two or more different wetting agents. A wetting agent is preferably present in an amount of between 0 to up to 10% (w/v), more preferred between 0.01 to up to 5% (w/v), more preferred between 0.02 to up to 1% (w/v), more preferred about 0.05% (w/v).

In some embodiments, the wetting agent is polyalkylene oxide block copolymer. In some embodiments, the wetting agent is butyl block copolymer. In some embodiments, the butyl block copolymer is Atlas™ G5002L (sold by Croda). In some embodiments the wetting agent is Adsee 900, a decyl alcohol ethoxylate.

In some embodiments, the concentration of the wetting agent in the composition is 1-10% by weight based on the total weight of the composition. In some embodiments, the concentration of the wetting agent in the composition is 0-5% by weight based on the total weight of the composition. In some embodiments, the concentration of the wetting agent in the composition is 1-5% by weight based on the total weight of the composition. In some embodiments, the concentration of the wetting agent in the composition is 1-3% by weight based on the total weight of the composition. In some embodiments, the concentration of the wetting agent in the composition is about 2% by weight based on the total weight of the composition.

In some embodiments, the composition comprises at least one rheology modifier. In some embodiments, the agriculturally acceptable additive is a rheology modifier.

In some embodiments, the rheology modifier is a thickener. In some embodiments, the composition comprises at least one thickener.

A thickening agent, when present, is preferably selected from agar, alginic acid, alginate, carrageenan, gellan gum, xanthan gum, succinoglycan gum, guar gum, acetylated distarch adipate, acetylated oxidised starch, arabinogalactan, ethyl cellulose, methyl cellulose, locust bean gum, starch sodium octenylsuccinate, and triethyl citrate.

A composition of the invention may also comprise two or more different thickening agents. A thickening agent is preferably present in an amount of between 0 to up to 10% (w/v), more preferred between 0.01 to up to 5% (w/v), more preferred between 0.02 to up to 1% (w/v), more preferred about 0.05% (w/v).

In some embodiments, the thickener is xanthan gum.

In some embodiments, the rheology modifier is Rhodopol® 23 (sold by Solvay). In some embodiments, the rheology modifier is xanthan gum.

In some embodiments, the concentration of the rheology modifier in the composition is 0.01-10% by weight based on the total weight of the composition. In some embodiments, the concentration of the rheology modifier in the composition is 5-10% by weight based on the total weight of the composition. In some embodiments, the concentration of the rheology modifier in the composition is about 6% by weight based on the total weight of the composition. In some embodiments, the concentration of the rheology modifier in the composition is about 8% by weight based on the total weight of the composition.

In some embodiments, the composition comprises at least one thickener and at least one biocide. In some embodiments, the amount of the thickener and the biocide in the composition is up to 1% by weight based on the total weight of the composition.

In some embodiments, the agriculturally acceptable additive is a preservative. In some embodiments, the composition comprises at least one preservative.

In some embodiments, the preservative is a biocide. In some embodiments, the composition comprises at least one biocide. In some embodiments, the preservative is Acticide® MBS.

In some embodiments, the concentration of the preservative in the composition is 0.01-5% by weight based on the total weight of the composition. In some embodiments, the concentration of the preservative in the composition is 0.01-1% by weight based on the total weight of the composition. In some embodiments, the concentration of the preservative in the composition is about 0.1% by weight based on the total weight of the composition. In some embodiments, the concentration of the preservative in the composition is 0.083% by weight based on the total weight of the composition.

A composition according to the invention may comprise an additional bioactive ingredient, also termed additional agrochemical, such as a growth regulator, a bio-stimulant, a fungicide, a herbicide, an insecticide, an acaricide, a molluscicide, a miticide, a rodenticide; and/or an bactericide.

Various agrochemicals may be used as additional bioactive ingredient. Exemplary among such agrochemicals without limitation are crop protection agents, for example pesticides, safeners, plant growth regulators, repellents, bio-stimulants and preservatives such as bacteriostats or bactericides.

In some embodiments, the composition comprises at least one additional bioactive ingredient, preferably an additional insecticide, fungicide and/or herbicide.

Additional agrochemicals that may be used with the combination, composition and macromolecular complex of the present invention are described below.

A composition of the invention may also comprise two or more additional bioactive ingredients, such as two or more fungicides, two or more herbicides, two or more insecticides, two or more acaricides, two or more bactericides, or combinations thereof, such as at least one antifungal compound and at least one insecticide, at least one antifungal compound and at least one herbicide, at least one antifungal compound and at least one acaricide, at least one antifungal compound and at least one bactericide, at least one herbicide and at least one insecticide, at least one herbicide and at least one acaricide, at least one herbicide and at least one bactericide, at least one insecticide and at least one acaricide, at least one insecticide and at least one bactericide, and at least one acaricide and at least one bactericide. Some bioactive ingredients have a wide range of target organisms, as is known to the skilled person, and are therefore include in more than one subgroup of bioactive ingredients. Said at least one additional bioactive ingredient preferably is present in a concentration of between 0.1 and 90 w/v %, more preferred between 1 and 70 w/v %, more preferred between 10 and 50 w/v %.

Said additional bioactive ingredient preferably is an insecticide, a fungicide and/or an herbicide.

A preferred additional insecticide is a carbamate such as carbofuran, propoxur, methomyl, bendiocarb, formetanate, oxamyl, and aldicarb, an organochlorine such as methoxychlor, kelthane, lindane, toxaphene, and cyclodiene insecticides such as aldrin, dieldrin, endrin, mirex, chlordane, heptachlor, and endosulfan, an organophosphate such as parathion, malathion, methyl parathion, chlorpyrifos, diazinon, dichlorvos, phosmet, fenitrothion, tetrachlorvinphos, azamethiphos, azinphos-methyl, and terbufos, a formamidine such as amitraz, chlordimeform, formetanate, formparanate, medimeform, and semiamitraz, an organosulfur such as dipymetitrone, an avermectin such as ivermectin, doramectin, selamectin, milbemycin oxime and moxidectin, a neonicotinoid such as acetamiprid, clothianidine, imidacloprid, nitenpyram, nithiazine, thiacloprid and thiamethoxam and/or a pyrethroid insecticide such as allethrin, bifenthrin, cyfluthrin, cypermethrin, cyphenothrin, deltamethrin, esfenvalerate, etofenprox, fenpropathrin, fenvalerate, flucythrinate, flumethrin, fmiprothrin, lambda-cyhalothrin, metofluthrin, permethrin, resmethrin, silafluofen, sumithrin, tau-fluvalinate, tefluthrin, tetramethrin, tralomethrin, and transfluthrin.

A preferred additional fungicide is selected from mancozeb, sodium ortho-phenylphenate, 2-phenylphenol; 8-hydroxyquinoline sulphate; acibenzolar-5-methyl; actinovate; aldimorph; amidoflumet; ampropylfos; ampropylfos-potassium; andoprim; anilazine; azoxystrobin; benalaxyl; benodanil; benomyl (methyl 1-(butylcarbamoyl)benzimidazol-2-ylcarbamate); benthiavalicarb-isopropyl; benzamacril; benzamacril-isobutyl; bilanafos; binapacryl; biphenyl; blasticidin-S; boscalid; bupirimate; buthiobate; butylamine; calcium polysulphide; capsimycin; captafol; captan (N-(trichloromethylthio)cyclohex-4-ene-1,2-dicarboximide); carbendazim; carboxin; carpropamid; carvone; chinomethionat; chlobenthiazone; chlorfenazole; chloroneb; chlorothalonil; chlozolinate; cis-1-(4-chlorophenyl)-2-(1H-1,2,4-triazol-1-yl)-cycloheptanol; clozylacon; a conazole fungicide such as, for example, (RS)-1-(β-allyloxy-2,4-dichlorophenethyl)imidazole (imazalil; Janssen Pharmaceutica NV, Belgium) and N-propyl-N-[2-(2,4,6-trichlorophenoxy)ethyl]imidazole-1-carboxamide (prochloraz); cyazofamid; cyflufenamid; cymoxanil; cyprodinil; cyprofuram; Dagger G; debacarb; dichlofluanid; dichlone; dichlorophen; diclocymet; diclomezine; dicloran; diethofencarb; diflumetorim; dimethirimol; dimethomorph; dimoxystrobin; dinocap; diphenylamine; dipyrithione; ditalimfos; dithianon; dodine; drazoxolon; edifenphos; ethaboxam; ethirimol; etridiazole; famoxadone; fenamidone; fenapanil; fenfuram; fenhexamid; fenitropan; fenoxanil; fenpiclonil; fenpropidin; fenpropimorph; fluazinam (3-chloro-N-(3-chloro-5-trifluoromethyl-2-pyridyl)-α,α,α-trifluoro-2,6-dinitro-p-toluidine); flubenzimine; fludioxonil; flumetover; flumorph; fluoromide; fluoxastrobin; fluopicolide; flurprimidol; flusulfamide; flutolanil; folpet (N-(trichloromethylthio)phthalimide); fosetyl-A1; fosetyl-sodium; fuberidazole; furalaxyl; furametpyr; furcarbanil; furmecyclox; guazatine; hexachlorobenzene; hymexazol; iminoctadine triacetate; iminoctadine tris(albesilate); iodocarb; iprobenfos; iprodione; iprovalicarb; irumamycin; isoprothiolane; isovaledione; kasugamycin; kresoxim-methyl; mandipropamid, meferimzone; mepanipyrim; mepronil; metalaxyl; metalaxyl-M; methasulfocarb; methfiroxam; methyl 1-(2,3-dihydro-2,2-dimethyl-1H-inden-1-yl)-1H-imidazole-5-carboxylate; methyl 2-[[[cyclopropyl[(4-methoxyphenyl)imino]methyl]thio]-methyl]-.alph-a.-(methoxymethylene)benzeneacetate; methyl 2-[2-[3-(4-chlorophenyl)-1-methyl-allylideneaminooxymethyl]phenyl]-3-meth-oxyacrylate; metiram; metominostrobin; metrafenone; metsulfovax; mildiomycin; monopotassium carbonate; myclozolin; N-(3-ethyl-3,5,5-trimethylcyclohexyl)-3-formylamino-2-hydroxybenzamide; N-(6-methoxy-3-pyridinyl)cyclopropanecarboxamide; a polyene fungicide such as natamcyin; N-butyl-8-(1,1-dimethylethyl)-1-oxaspiro[4.5]decan-3-amine; nitrothal-isopropyl; noviflumuron; ofurace; orysastrobin; oxadixyl; oxolinic acid; oxycarboxin; oxyfenthiin; pencycuron; penthiopyrad; phosdiphen; phosphite salts such as disodium phosphite and potassium phosphite, phthalide; picobenzamid; picoxystrobin; piperalin; polyoxins; polyoxorim; procymidone; propamocarb; propanosine-sodium; propineb; proquinazid; prothioconazole; pyraclostrobin; pyrazophos; pyrimethanil; pyroquilon; pyroxyfur; pyrrolnitrine, quinconazole; quinoxyfen; quintozene; silthiofam; sodium tetrathiocarbonate; spiroxamine; sulphur; tecloftalam; tecnazene; tetcyclacis; thiazole fungicide such as, for example, 2-(thiazol-4-yl)benzimidazole (thiabendazole), thicyofen; thifluzamide; thiophanate-methyl; tiadinil; tioxymid; tolclofos-methyl; tolylfluanid; triazbutil; triazoxide; tricyclamide; tricyclazole; tridemorph; trifloxystrobin; validamycin A; vinclozolin; zoxamide; (2S)— N-[2-[4-[[3-(4-chlorophenyl)-2-propynyl]oxy]-3-methoxyphenyl]ethyl]-3-met-hyl-2-[(methylsulphonyl)amino]butanamide; 1-(1-naphthalenyl)-1H-pyrrole-2,5-dione; 2,3,5,6-tetrachloro-4-(methylsulphonyl)pyridine; 2,4-dihydro-5-methoxy-2-methyl-4-[[[[1-[3-(trifluoromethyl)phenyl]-ethyli-dene]amino]oxy]methyl]phenyl]-3H-1,2,3-triazol-3-one; 2-amino-4-methyl-N-phenyl-5-thiazolecarboxamide; 2-chloro-N-(2,3-dihydro-1,1,3-trimethyl-1H-inden-4-yl)-3-pyridinecarboxam-ide; 3,4,5-trichloro-2,6-pyridinedicarbonitrile; 3-[(3-bromo-6-fluoro-2-methyl-1H-indol-1-yl)sulphonyl]-N,N-dimethyl-1H-1,-2,4-triazole-1-sulphonamide, and/or mixtures thereof.

In some embodiments, the additional fungicide is natamycin. A composition of the invention may also comprise two or more additional fungicides, such as, for example, natamycin and a strobilurin type of fungicides such as azoxystrobin, picoxystrobin, natamycin and a triazole type of fungicides such as cyproconazole, prothioconazole, natamycin and a succinate dehydrogenase inhibitor type of fungicides such as boscalid, natamycin and a pthalimide/pthalonitrile type of fungicide such as chlorothalonil, natamycin and captan, natamycin and a benzimidazole type of fungicide such as thiabendazole, natamycin and a carbamate type of fungicides such as propamocarb, natamycin and a carboxamide type of fungicides such as fenoxanil, natamycin and a dicarboxamide type of fungicide such as iprodione, natamycin and a morpholine type of fungicide such as dimethamorph, natamycin and an organophosphate type of fungicide such as fosetyl, natamycin and an azole type of fungicide such as prothioconazole, a benzamide type of fungicide (such as fluopicolide), natamycin and a phenylamide type of fungicide suich as metalaxyl, natamycin and a fungicide not belonging to a specific group of fungicides such as fludioxynil and/or folpet.

A preferred additional herbicide is selected from an inhibitor of amino acid synthesis such as inhibitors of 5-enolpyruvyl-shikimate-3-phosphate synthase, acetolactate synthase and glutamine synthetase such as a glyphosate, a sulfonylurea, an imidazolinone, a glufosinate and/or a 1,2,4-triazol [1,5A] pyrimidine; a photosynthetic inhibitor that binds D-1:quinone-binding protein, including anilides, benzimidazoles, biscarbamates, pyridazinones, triazinediones, triazines, triazinones, uracils, substituted ureas, quinones, hydroxybenzonitriles, and several unclassified heterocycles; inhibitors of acetyl-CoA carboxylase such as aryloxyphenoxy alkanoic acids and cyclohexanediones; inhibitors of cellular division such as phosphoric amide and dinitroaniline; inhibitors of the terpenoid synthesis pathway such as substituted pyridazinones, m-phenoxybenzamides, fluridone, difunone, 4-hydroxypyridine, aminotriazole amitrole, 6-methyl pyrimidine, isoxazolidinone; inhibitors of dihydropteroate synthase such as asulam, and/or mixtures thereof.

Such preferred additional herbicide is preferably selected from benzobicyclon, mesotrione, sulcotrione, tefuryltrione, tembotrione, 2,4-dichlorophenoxyacetic acid, 3,6-dichloro-2-methoxybenzoic acid (dicamba), 4-hydroxy-3-[[2-(2-methoxyethoxy)methyl]-6-(trifluoromethyl)-3-pyridinyl]carbonyl]-bicyclo[3.2.1]-oct-3-en-2-one (bicyclopyrone), ketospiradox or the free acid thereof, benzofenap, pyrasulfotole, pyrazolynate, pyrazoxyfen, topramezone, [2-chloro-3-(2-methoxyethoxy)-4-(methylsulfonyl)phenyl](1-ethyl-5-hydroxy-1 H-pyrazol-4-yl)-methanone, (2,3-dihydro-3,3,4-trimethyl-1, 1-dioxidobenzo[b]thien-5-yl)(5-hydroxy-1-methyl-1 H-pyrazol-4-yl)-methanone, isoxachlortole, isoxaflutole, a-(cyclopropylcarbonyl)-2-(methylsulfonyl)-oxo-4-chloro-benzenepropanenitrile, and a-(cyclopropylcarbonyl)-2-(methylsulfonyl)-oxo-4-(trifluoromethyl)-benzenepropanenitrile.

Preferred additional fungicides are strobilurin fungicide and azole fungicides.

Strobilurin fungicide may be, but is not limited to, picoxystrobin, azoxystrobin or a combination thereof.

Azole fungicide may be, but is not limited to, tebuconazole, prothioconazole, or a combination thereof.

In some embodiments, benzamide fungicide is fluopicolide,

In some embodiments, when one or more additional fungicides are added to the composition, the dispersant a mixture of anionic tristyrylphenol phosphate surfactants (such as Soprophor FL or Soprophor 3D33) and a high HLB nonionic polyalkylene oxide block polymer surfactant (such as Atlas G5002L) or nonionic alcohol ethoxylate (such as ECOSURF EH6).

In some embodiments, the combination, composition and macromolecular complex of the present invention is combined with two additional fungicides. In some embodiments, the combination, composition and macromolecular complex of the present invention is combined with picoxystrobin and tebuconazole. In some embodiments, the combination, composition and macromolecular complex is combined with picoxystrobin and tebuconazole. In some embodiments, the combination, composition and macromolecular complex is combined with prothioconazole. In some embodiments, the combination, composition and macromolecular complex is combined with picoxystrobin and prothioconazole. In some embodiments, the combination, composition, and macromolecular complex is combined with fluopicolide.

In some embodiments, the combination, composition and macromolecular complex is combined with azoles and carboxamides. In some embodiments, the carboxamide is fluxapyroxad.

In some embodiments, the combination, composition and macromolecular complex is combined with morpholines. In some embodiments, the morpholine is fenpropidin.

In some embodiments, the composition comprising copper-based fungicide and polyelectrolyte further comprises picoxystrobin and tebuconazole. In some embodiments, the composition comprising copper-based fungicide and polyelectrolyte further comprises prothioconazole. In some embodiments, the composition comprising copper-based fungicide and polyelectrolyte further comprises picoxystrobin and prothioconazole. In some embodiments, the composition comprising copper-based fungicide and polyelectrolyte further comprises fluopicolide.

In some embodiments, the polyelectrolyte comprises at least one polyanion. In some embodiments, the polyelectrolyte is a polyanion. In some embodiments, the polyelectrolyte comprises a polycation and a polyanion. In some embodiments, the polyelectrolyte is a complex of a polycation and a polyanion.

A composition of the invention may also comprise two or more additional bioactive ingredients, such as two or more fungicides, two or more herbicides, two or more insecticides, two or more acaricides, two or more bactericides, or combinations thereof, such as at least one antifungal compound and at least one insecticide, at least one antifungal compound and at least one herbicide, at least one antifungal compound and at least one acaricide, at least one antifungal compound and at least one bactericide, at least one herbicide and at least one insecticide, at least one herbicide and at least one acaricide, at least one herbicide and at least one bactericide, at least one insecticide and at least one acaricide, at least one insecticide and at least one bactericide, and at least one acaricide and at least one bactericide. Some bioactive ingredients have a wide range of target organisms, as is known to the skilled person, and are therefore include in more than one subgroup of bioactive ingredients. Said at least one additional bioactive ingredient preferably is present in a concentration of between 0.1 and 90 w/v %, more preferred between 1 and 70 w/v %, more preferred between 10 and 50 w/v %.

Said additional bioactive ingredient preferably is an insecticide, a fungicide and/or an herbicide.

In some embodiments, the additional bioactive ingredient is an azole fungicide.

In some embodiments, the additional bioactive ingredients are an azole fungicide and a strobilurin fungicide. In some embodiments, the strobilurin fungicide is picoxystrobin.

In some embodiments, the azole fungicide is prothioconazole.

In some embodiments, the additional bioactive ingredients are an azole fungicide and a carboxamide fungicide. In some embodiments, the carboxamide fungicide is fluxapyroxad.

In some embodiments, the additional bioactive ingredient is a benzamide fungicide. In some embodiments, the benzamide fungicide is fluopicolide.

In some embodiments, the additional bioactive ingredients are an azole fungicide and a morpholine fungicide. In some embodiments, the morpholine fungicide is fenpropidin.

In some embodiments, the copper-based fungicide used in combination with the azole fungicide, strobilurin fungicide, carboxamide fungicide and/or morpholine fungicide is copper oxychloride, copper hydroxide, copper sulfate, cupric acetate, cupric chloride, cupric chlorate, cupric formate, cupric hexafluorosilicate, cupric nitrate, cupric chromate, copper sulfate pentahydrate, bordeaux mixture and/or any combination thereof.

In some embodiments, the composition is substantially free of an agriculturally acceptable organic solvent. In some embodiments, the composition is aqueous.

In some embodiments, the composition is a suspension concentrate.

In some embodiments, the suspension concentrate composition comprises:

The present invention provides a concentrate composition comprising (1) a copper-based fungicide, (2) a polyelectrolyte, and (3) an aqueous carrier.

The present invention also provides a suspension concentrate comprising (1) a copper-based fungicide, (2) a polyelectrolyte, and (3) an aqueous carrier.

The present invention provides a concentrate composition comprising a (1) a macromolecular complex comprising (i) a copper-based fungicide and (ii) a polyelectrolyte, and (2) an aqueous carrier.

The present invention also provides a suspension concentrate comprising (1) a macromolecular complex comprising (i) a copper-based fungicide and (ii) a polyelectrolyte, and (2) an aqueous carrier.

The present invention provides a composition comprising (i) macromolecular complex comprising copper-based fungicide and polyelectrolyte, (ii) at least one additional fungicide and (iii) at least one agriculturally acceptable additive.

The present invention provides a composition comprising copper-based fungicide and polyelectrolyte.

The present invention provides a composition comprising (i) copper-based fungicide (ii) polyelectrolyte, (iii) at least one additional fungicide and (iv) at least one agriculturally acceptable additive.

In some embodiments, the composition comprises 40-80% by weight of water. In some embodiments, the composition comprises 50-70% by weight of water. In some embodiments, the composition comprises 50-55% by weight of water. In some embodiments, the composition comprises 40-80% by weight of water. In some embodiments, the composition comprises about 51% by weight of water. In some embodiments, the composition comprises about 62% by weight of water. In some embodiments, the composition comprises 30-50% by weight of water. In some embodiments, the composition comprises 30-60% by weight of water. In some embodiments, the composition comprises 30-80% by weight of water.

In some embodiments, the additional fungicide is selected from the group consisting of azole fungicides, strobilurin fungicides, benzamide fungicide, morpholines, QiI fungicide, SDHI and any combination thereof.

In some embodiments, the azole fungicide is triazole fungicide.

In some embodiments, azole fungicide may include but is not limited to azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, metconazole, myclobutanil, penconazole, propiconazole, simeconazole, tebuconazole, tetraconazole, triadimefon, triadimenol, triticonazole and prothioconazole, Mefentrifluconazole.

In some embodiments, strobilurin fungicide may include but is not limited to azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, trifloxystrobin, dimoxystrobin, fenaminstrobin, metominostrobin, orysastrobin, metyltetraprole and fluoxastrobin.

In some embodiments, the strobilurin fungicide is selected from group consisting of picoxystrobin, trifloxystrobin, azoxystrobin, pyraclostrobin, metominostrobin, metyltetraprole, mandestrobin and a combination thereof.

In some embodiments, the SDHI may include but is not limited to penthiopyrad, boscalid, flutolanil, fluxapyroxad, inpyrfluxam, fluopyram, fluindapyr, benzodiflupyr, bixafen and pydiflumetofen

In some embodiments, the SDHI fungicide is selected from group consisting of bixafen; fluxapyroxad, fluindapyr; inpyrfluxam, benzodiflupyr and pydiflumetofen.

In some embodiments, QiI fungicide may include but is not limited to cyazofamid, amisulbrom and fenpicoxamid.

In some embodiments, Morpholines may include but is not limited to aldimorph, fenpropimorph, ridemorph, dodemorph, spiroxamine, piperalin, fenpropidin.

In a preferred embodiment, the subject matter relates to a composition comprising: a) copper-based fungicide, prothioconazole and picoxystrobin suspended in the water.

In another preferred embodiment, the subject matter relates to a composition comprising: a) the copper-based fungicide and picoxystrobin are suspended in water; and b) the prothioconazole dissolved in the water-immiscible carrier.

In another preferred embodiment, the subject matter relates to a composition comprising: a) a copper-based fungicide and fluopicolide, suspended in water.

In an embodiment, the amount of the additional fungicide(s) may be present in a concentration of about 0.1-30 wt. %, based on the total weight of the composition. In a further embodiment, the amount of the additional fungicide(s) may be present in a concentration of about 1-15% by weight based upon the total weight of the composition. In another embodiment, the amount of the additional fungicide(s) may be present in a concentration of about 1-10% by weight based upon the total weight of the composition. In yet another embodiment, the amount of the additional fungicide may be present in a concentration of about 3-8% by weight based upon the total weight of the composition. In a specific embodiment, the amount of the additional fungicide(s) may be present in a concentration of about 5.6% by weight based upon the total weight of the composition.

In some embodiments, water-immiscible carrier may include but is not limited to aromatic hydrocarbons (e.g., toluene, o-, m-, p-xylene, ethylbenzene, isopropylbenzene, tert-butylbenzene, naphthalenes, mono- or polyalkyl-substituted naphthalenes), paraffins (e.g. octane, nonane, decane, undecane, dodecane, tridecane, tetradecane, pentadecane, hexadecane, hepta-decane, octa-decane, nona-decane, eicosane, heneicosane, docosane, tricosane, tetracosane, pentacosane, and branched chain isomers thereof), petroleum, ketones (e.g. acetophenone, cyclohexanone), vegetable oil (e.g. olive oil, kapok oil, castor oil, papaya oil, camellia oil, palm oil, sesame oil, corn oil, rice bran oil, peanut oil, cotton seed oil, soybean oil, rapeseed oil, linseed oil, tung oil, sunflower oil, safflower oil, tall oil), alkyl ester of vegetable oils, (e.g. rapeseed oil methyl ester or rapeseed oil ethyl ester, rapeseed oil propyl esters, rapeseed oil butyl esters, tall oil fatty acids esters etc.), diesel, mineral oil, fatty acid amides (e.g. C₁-C₃ amines, alkylamines or alkanolamines with C₆-Cis carboxylic acids), fatty acids, tall oil fatty acids, alkyl esters of fatty acids (e.g. C₁-C₄ monohydric alcohol esters of C₈ to C₂₂ fatty acids such as methyl oleate, ethyl oleate), modified vegetable oils and combinations thereof.

In a preferred embodiment, the water immiscible carrier may include but is not limited to aromatic hydrocarbons, fatty acid amides, alkyl ester of vegetable oils and vegetable oils.

In an embodiment, the amount of the water immiscible carrier may be about 0.1-20 wt. %, about 1-15 wt. %, or about 0.1-10 wt. %, or about 1-5% based on the total weight of the composition. In a specific embodiment, the non-aqueous liquid carrier may be present in a concentration of about 3% by weight based upon the total weight of the composition.

In some embodiments, embodiments, the adjuvant in the liquid carrier may include but is not limited to vegetable oils, alkyl esters of vegetable oils such as for example, soy methyl ester, soy ethyl ester, rapeseed oil methyl ester or rapeseed oil ethyl ester, alkoxylated sorbitan esters such as for example sorbitan monolaurate alkoxylates such as for example polyoxyethylene (16) sorbitan monolaurate (Tween™ 24), polyoxyethylene (20) sorbitan monolaurate (Tween™ 20; Alkamuls® PSML-20), polyoxyethylene (4) sorbitan monolaurate (Tween™ 21), polyoxyethylene (8) sorbitan monolaurate (Tween™ 22), polyoxyethylene (12) sorbitan monolaurate (Tween™ 23), sorbitan monolaurate (Alkamuls® S/20, Glycomul® LK, Glycomul® LC, Span® 20), polyoxyethylene (20) sorbitan monostearate alkoxylates such as for example polyoxyethylene (20) sorbitan monostearate (Tween™ 60), polyoxyethylene (4) sorbitan monostearate (Tween™ 61), sorbitan monostearate (Alkamuls® S/90, Glycomul® S, Span® 60), sorbitan monooleate alkoxylates such as for example polyoxyethylene (20) sorbitan monooleate (Tween™ 80, Emulgin® SMO 20, T-Maz® 80, Agnique® SMO 20U), polyoxyethylene (5) sorbitan monooleate (Tween™ 81), sorbitan monooleate (Alkamuls® S/80, Span® 80), and combinations thereof.

A composition according to the invention provides a stable aqueous suspension comprising a high concentration of a copper-based fungicide up to about 30% (w/w), with improved fungicidal activity and/or effective control of plant health compared to commercially available formulations of said copper-based fungicide

A composition according to the invention provides a stable aqueous suspension comprising a high concentration of a copper-based fungicide up to about 50% (w/v), with improved fungicidal activity and/or effective control of plant health compared to commercially available formulations of said copper-based fungicide, in the presence of relatively low amounts of adjuvants as agriculturally acceptable carriers.

In some embodiments, the macromolecular complex is made by pre-mixing the polyelectrolyte and the copper-based fungicide prior to addition of the other additive.

In some embodiments, the amount of the copper-based fungicide is more effective than if the same type and amount of copper base fungicide is formulated in the absence of polyelectrolyte.

In some embodiments, the amount of the copper-based fungicide is more effective in promoting growth of a crop plant in the presence of a fungus than if the same type and amount of copper base fungicide is formulated in the absence of polyelectrolyte.

In some embodiments, more effective refers but is not limited to biological control, rainfastness, adherence to leaves, controlled release, preventive efficacy, and/or increasing the plant health.

The present invention also provides a composition comprising (1) copper-based fungicide, (2) a polyelectrolyte, and (3) at least one agriculturally acceptable additive, wherein the composition has any one or any combination of the following features:
a. the composition is more fungicidally effective compared to a composition of copper-based fungicide which is not made in the presence of the polyelectrolyte,
b. the composition is more fungicidally effective compared to a composition of copper-based fungicide which is formulated in the absence of the polyelectrolyte,
c. the composition has improved leaf adhesion compared to a composition of copper-based fungicide which is formulated in the absence of the polyelectrolyte,
d. the composition has improved rainfastness compared to a composition of copper-based fungicide which is formulated in the absence of the polyelectrolyte,
e. the composition has decreased drift compared to a composition with of copper-based fungicide which is formulated in the absence of the polyelectrolyte, and
f. the composition has controlled bioavailability compared to a composition of copper-based fungicide which is formulated in the absence of the polyelectrolyte.

In some embodiments, controlled bioavailability means controlled rate of release of Cu²⁺.

The present invention provides a composition comprising:
(i) 28.8% by weight of Bordeaux,
(ii) 53.8% by weight of water,
(iii) 0.5% by weight of chitosan,
(iv) 2.3% by weight of calcium lignosulfonate,
(v) 2% by weight of Metasphere 500L,
(vi) 2% by weight of Atlas G5002L,
(vii) 0.4% by weight of Silicolapse 426R,
(viii) 4.2% by weight of propane-1,2-diol,
(ix) 0.083% by weight of Acticide® MBS, and
(x) 6% by weight of Rhodopol 23.

The present invention provides a composition comprising:
(i) 28.8% by weight of Bordeaux,
(ii) 55% by weight of water,
(iii) 0.5% by weight of chitosan,
(iv) 2.3% by weight of calcium lignosulfonate,
(v) 1% by weight of Tensiofix CGA213,
(vi) 2% by weight of Tensiofix LB350,
(vii) 0.2% by weight of Tensiofix L051,
(viii) 4.2% by weight of propane-1,2-diol,
(ix) 0.083% by weight of Acticide® MBS, and
(x) 6% by weight of Rhodopol 23.

The present invention provides a composition comprising:
(ii) 28.8% by weight of Bordeaux,
(iii) 52.3% by weight of water,
(iv) 2.3% by weight of calcium lignosulfonate,
(v) 2% by weight of Metasphere 500L,
(vi) 2% by weight of Atlas G5002L,
(vii) 0.4% by weight of Silicolapse 426R,
(viii) 4.2% by weight of propane-1,2-diol,
(ix) 0.083% by weight of Acticide® MBS, and
(x) 8% by weight of Rhodopol 23.

The present invention provides a composition comprising:
(i) 28.8% by weight of Bordeaux,
(ii) 53.4% by weight of water,
(iii) 2.3% by weight of calcium lignosulfonate,
(iv) 1% by weight of Tensiofix CGA213,
(v) 2% by weight of Tensiofix LB350,
(vi) 0.2% by weight of Tensiofix L051,
(vii) 4.2% by weight of propane-1,2-diol,
(viii) 0.083% by weight of Acticide® MBS, and
(ix) 8% by weight of Rhodopol 23.

The present invention provides a composition comprising:
(i) 30.5% by weight of Cu-oxychloride,
(ii) 5% by weight of Picoxystrobine (99)
(iii) 5.8% by weight of Prothioconazole (99,3)
(iv) 35.8% by weight of water,
(v) 2.6% by weight of Na citrate
(vi) 2.8% by weight of calcium lignosulfonate,
(vii) 0.3% by weight of chitosan
(viii) 5% by weight of Tergitol XD,
(ix) 0.9% by weight of Ecosurf EH6,
(x) 3.6% by weight of propane-1,2-diol,
(xi) 0.4% by weight of silcolapse 426R, and
(xii) 7.5% by weight of Rhodopol 23.

The present invention provides a composition comprising:
(i) 31.7% by weight of Bordeaux Mixture
(ii) 2.6% by weight of Picoxystrobine (99)
(iii) 3.0% by weight of Prothioconazole (99,3)
(iv) 41.2% by weight of water,
(v) 1.5% by weight of Na citrate
(vi) 1.0% by weight of calcium lignosulfonate,
(vii) 0.2% by weight of chitosan
(viii) 7.4% by weight of soprophor FL,
(ix) 1.5% by weight of atlas G5002L,
(x) 3.7% by weight of propane-1,2-diol,
(xi) 0.7% by weight of silcolapse 426R,
(xii) 0.1% by weight of acticide MBS and
(xiii) 6.3% by weight of Rhodopol 23.

The present invention provides a composition comprising:
(i) 31.7% by weight of Bordeaux Mixture
(ii) 2.6% by weight of Picoxystrobine (99)
(iii) 3.0% by weight of Prothioconazole (99,3)
(iv) 38.8% by weight of water,
(v) 1.5% by weight of dipotassiumhydrogenphosphate
(vi) 2.1% by weight of calcium lignosulfonate,
(vii) 0.4% by weight of chitosan
(viii) 0.2% by weight of acetic acid
(ix) 7.4% by weight of soprophor FL,
(x) 1.5% by weight of atlas G5002L,
(xi) 3.7% by weight of propane-1,2-diol,
(xii) 0.7% by weight of silcolapse 426R,
(xiii) 0.1% by weight of acticide MBS and
(xiv) 6.3% by weight of Rhodopol 23.

The present invention provides a composition comprising:
(i) 31.7% by weight of Bordeaux Mixture
(ii) 2.6% by weight of Picoxystrobine (99)
(iii) 3.0% by weight of Prothioconazole (99,3)
(iv) 41.9% by weight of water,
(v) 1.5% by weight of Na citrate
(vi) 2% by weight of calcium lignosulfonate,
(vii) 0.5% by weight of chitosan
(viii) 7.4% by weight of soprophor FL,
(ix) 1.5% by weight of atlas G5002L,
(x) 3.7% by weight of propane-1,2-diol,
(xi) 0.7% by weight of silcolapse 426R,
(xii) 0.1% by weight of acticide MBS and
(xiii) 3.4% by weight of Rhodopol 23.

The present invention provides a composition comprising:
(i) 35.5% by weight of Cu-oxychloride
(ii) 5.6% by weight of fluopicolide
(iii) 36.9% by weight of water,
(iv) 3.6% by weight of calcium lignosulfonate,
(v) 0.4% by weight of chitosan
(vi) 2.5% by weight of soprophor 3D33,
(vii) 1.0% by weight of ecosurf EH6,
(viii) 4.2% by weight of propane-1,2-diol,
(ix) 0.4% by weight of silcolapse 426R, and
(x) 10% by weight of Rhodopol 23.

The present invention provides a composition comprising:
(i) 35.5% by weight of Cu-oxychloride
(ii) 5.6% by weight of fluopicolide
(iii) 41.5% by weight of water,
(iv) 3.6% by weight of calcium lignosulfonate,
(v) 0.7% by weight of PAA
(vi) 2.5% by weight of atlox 4913,
(vii) 1.0% by weight of adsee900,
(viii) 4.2% by weight of propane-1,2-diol,
(ix) 0.4% by weight of silcolapse 426R, and
(x) 5% by weight of Rhodopol 23.

The present invention provides a composition comprising:
(i) 35.5% by weight of Cu-oxychloride
(ii) 5.6% by weight of fluopicolide
(iii) 39.4% by weight of water,
(iv) 3.3% by weight of calcium lignosulfonate,
(v) 0.7% by weight of chitosan
(vi) 2.5% by weight of atlox 4913,
(vii) 1.0% by weight of adsee900,
(viii) 4.2% by weight of propane-1,2-diol,
(ix) 0.4% by weight of silcolapse 426R, and
(x) 7.5% by weight of Rhodopol 23.

The present invention provides a composition comprising:
(i) 34.29% by weight of Bordeaux Mixture
(ii) 2.78% by weight of Picoxystrobine
(iii) 5.0% by weight of propane-1,2-diol,
(iv) 1.0% by weight of Metasperse 550 S,
(v) 2.8% by weight of Borresperse CA
(vi) 2% by weight of Geropon® T-77,
(vii) 2.0% by weight of Atlox 4894
(viii) 0.1% by weight of SAG 1572,
(ix) 0.05% by weight of Proxel GXL,
(x) 36.86% by weight of DM water,
(xi) 3.06% by weight of prothioconazol and
(xii) 3.06% by weight of Armid DM 10.

The present invention provides a composition comprising (1) macromolecular complex comprising (i) a copper-based fungicide and (ii) a polyelectrolyte, (2) at least one agriculturally acceptable additive and optionally (3) at least one additional fungicide.

The present invention also provides composition comprising (1) a copper-based fungicide, (2) a polyelectrolyte (3) at least one agriculturally acceptable additive and optionally (4) at least one additional fungicide.

The present invention also provides an aqueous composition comprising (1) a copper-based fungicide, (2) a polyelectrolyte, (3) water, and (4) at least one agriculturally acceptable additive.

The present invention provides a composition comprising (1) macromolecular complex comprising (i) a copper-based fungicide and (ii) a polyanion, optionally (2) at least one additional fungicide, and (3) at least one agriculturally acceptable additive.

The invention provides a macromolecular complex comprising (i) a copper-based fungicide and (ii) a polyanion.

### Delivery Systems

The invention also provides a pesticidal delivery system comprising any one of any combination, composition or macromolecular complexes described herein.

### Methods of Use

The present invention provides a method for controlling pathogen infection comprising applying a composition comprising (1) an amount of copper-based fungicide, (2) an amount of polyelectrolyte and (3) at least one agriculturally acceptable additive, wherein the application rate of the copper-based fungicide when is formulated with polyelectrolyte is less than when the same type of the copper base fungicide is formulated in the absence of polyelectrolyte.

In some embodiments, the amount of the copper-based fungicide is more effective than if the same type and amount of copper base fungicide is formulated in the absence of polyelectrolyte.

The present invention provides a method for improving efficacy of a copper-based fungicide comprising interacting the copper-based fungicide with a polyelectrolyte through intermolecular, non-covalent interactions before application of the copper-based fungicide.

In some embodiments, improving efficacy includes but is not limited to biological control, rainfastness, adherence to leaves, controlled release, preventive efficacy.

In some embodiments, the amount of the copper-based fungicide is more effective in promoting growth of a crop plant in the presence of a fungus than if the same type and amount of copper base fungicide is formulated in the absence of polyelectrolyte.

The present invention also provides use of the combination, macromolecular complex, composition, and/or delivery system described herein for treating a plant, or a part of a plant, against a pathogen.

The present invention also provides use of the combination, macromolecular complex, composition, and/or delivery system described herein for reducing the rate of application required for treating a plant, or a part of a plant, against a pathogen.

Said method or use of the composition, combination, delivery system and/or macromolecular complex, comprising a copper-based fungicide and a polyelectrolyte, may result in a reduced rate of application of the copper-based fungicide.

The terms “reduced rate of application” and “increasing biological activity” may refer to a rate of application that is more than 20%, preferably more than 50%, reduced, when compared to the rate of application of the same copper-based fungicide as a free copper-based fungicide.

The present invention provides a method of treating a plant, or a part of a plant, against a pathogen, comprising contacting the plant, or part of the plant, with any one or any combination of the macromolecular complexes described herein, and/or any one or any combination of the compositions described herein.

In some embodiments, treating comprises preventing, reducing and/or eliminating the presence of the pathogen on the plant, or part of the plant. In some embodiments, treating comprises controlling diseases caused by the pathogen.

The invention provides a method of increasing crop yield comprising contacting the plant, or part of the plant with any one of any combination, composition, macromolecular complexes and/or delivery system described herein.

The invention also provides a method of improving plant vigor comprising contacting the plant, or part of the plant with any one of any combination, composition, macromolecular complexes and/or delivery system described herein.

In some embodiments, the method of treating the plant, or the part of a plant against a pathogen comprises protecting the plant, or a part of a plant, against the pathogen, comprising contacting the plant, or part of the plant, with any one of any combination, composition, macromolecular complexes and/or delivery system described herein.

In some embodiments, the method of treating the plant, or the part of a plant against a pathogen comprises preventing, reducing and/or eliminating the presence of the pathogen on the plant, or part of the plant, comprising contacting the plant, or part of the plant, with any one of any combination, composition, macromolecular complexes and/or delivery system described herein.

In some embodiment, the method of treating the plant, or the part of a plant against a pathogen comprises controlling diseases caused by phytopathogenic fungi in plants or on propagation material thereof, which method comprises contacting the plants, or propagation material thereof, with any one of any combination, composition, macromolecular complexes and/or delivery system described herein.

In some embodiments, the method of treating the plant, or the part of a plant against a pathogen comprises improving pest control comprising applying any one of any combination, composition, macromolecular complexes and/or delivery system described herein to a plant/or soil.

In some embodiments, the method of treating the plant, or the part of a plant against a pathogen comprises prolonging a controlling effect of a copper-based fungicide, comprising applying any one of any combination, composition, macromolecular complexes and/or delivery system described herein to a plant/or soil.

In some embodiments, the pathogen is phytopathogenic fungi and the method comprises controlling diseases caused by phytopathogenic fungi in the plant or on propagation material thereof comprising contacting the plant, or propagation material thereof, with any one of any combination, composition, macromolecular complexes and/or delivery system described herein.

The invention further provides a method of protecting a plant or plant part against a pathogen, comprising contacting said plant or said plant part with a diluted aqueous composition according to this invention.

The invention further provides a method of preventing, reducing and/or eliminating the presence of a pathogen on a plant, or a part of a plant, comprising contacting said plant, or part of said plant, with an aqueous composition according to this invention.

In some embodiments, the method of treating the plant, or the part of a plant against a pathogen comprises preventing, reducing and/or eliminating the presence of the pathogen on the plant, or part of the plant, comprising contacting the plant, or part of the plant, with any one of any combination, composition, macromolecular complexes and/or delivery system described herein

The invention further provides a method of controlling diseases caused by phytopathogenic fungi in plants or on propagation material thereof, which method comprises contacting the plants, or propagation material thereof, with a composition according to the invention, including an aqueous diluted composition.

The present invention also provides a method of controlling pest comprising contacting (i) the pest or a locus thereof, (ii) a plant or a locus or propagation material thereof, (iii) soil, and/or (iv) an area in which pest infestation is to be prevented with a macromolecular complex of the invention. Said macromolecular complex of the invention preferably is provided as a composition according to the invention, and/or a delivery system according to the invention.

The present invention also provides a method for improving pest control comprising applying any one of the compositions, complexes or delivery systems described herein to a plant/or soil.

The present invention also provides a method for prolonging a controlling effect of a copper-based fungicide, comprising applying any one of the compositions, complexes or delivery systems described herein to a plant/or soil.

The present invention provides a method for controlling the release rate of copper cation from a copper-based fungicide comprising interacting the copper-based fungicide with a polyelectrolyte through intermolecular, non-covalent interactions before application of the copper-based fungicide.

In some embodiment, the combination of polyelectrolyte with the copper-based fungicide is before adding the co-formulants.

Rate of application may refer to an application rate of 22 g a.i./ha copper based fungicide (a.i.)/ha to 2.2 g a.i./ha, 0.22 g a.i./ha, 0.022 g a.i./ha, 0.0022 g a.i./ha, 750 g a.i./ha, 450 g a.i./ha, 375, 150 g a.i./ha, 15 g a.i./ha, 2.9 gr a.i./lit, 11.6 gr a.i./lit, preferably 0.0022 g a.i./ha to 0.75 kg a.i./ha. Rate of application may refer to an application rate of 22 g a.i./ha to 2.2 g a.i./ha of copper-based fungicide. In some embodiments, the copper-based fungicide is applied at a rate of 750 g a.i./ha, 605 mg a.i./ha, or 500 mg a.i./ha.

In some embodiments, the combination, composition, and/or delivery system is applied at an amount of 0.01-5 g/ha of the copper-based fungicide. In some embodiments, the combination, composition, and/or delivery system is applied at an amount of 0.01-3 g/ha of the copper-based fungicide. In some embodiments, the combination, composition, and/or delivery system is applied at an amount of 0.01-2 g/ha of the copper-based fungicide. In some embodiments, the combination, composition, and/or delivery system is applied at an amount of 0.01-1 g/ha of the copper-based fungicide.

In some embodiments, the combination, composition, and/or delivery system is applied at an amount of 0.018 g/ha of copper-based fungicide. In some embodiments, the combination, composition, and/or delivery system is applied at an amount of 0.97 g/ha of copper-based fungicide. In some embodiments, the combination, composition, and/or delivery system is applied at an amount of 0.39 g/ha of copper-based fungicide. In some embodiments, the combination, composition, and/or delivery system is applied at an amount of 1.56 g/ha of copper-based fungicide.

In some embodiments, the combination, composition, and/or delivery system is applied at an amount between 0.001 g/ha to 1000 g/ha of copper metal. In some embodiments, the combination, composition, and/or delivery system is applied at an amount between 100 g/ha to 1000 g/ha of copper metal. In some embodiments, the combination, composition, and/or delivery system is applied at an amount between 100 g/ha to 500 g/ha of copper metal. In some embodiments, the combination, composition, and/or delivery system is applied at an amount between 500 g/ha to 1000 g/ha of copper metal. In some embodiments, the combination, composition, and/or delivery system is applied at an amount between 0.001 g/ha to 100 g/ha of copper metal. In some embodiments, the combination, composition, and/or delivery system is applied at an amount between 0.001 g/ha to 50 g/ha of copper metal. In some embodiments, the combination, composition, and/or delivery system is applied at an amount between 0.001 g/ha to g/ha of copper metal. In some embodiments, the combination, composition, and/or delivery system is applied at an amount between 0.001 g/ha to 10 g/ha of copper metal.

In some embodiments, the combination, composition, and/or delivery system is applied at an amount of about 0.0022 g/ha, 0.022 g/ha, 0.22 g/ha, 2.2 g/ha or 22 g/ha of copper metal.

In some embodiments, the combination, composition, and/or delivery system is applied at an amount of about 0.0075 g/ha, 0.075 g/ha, 0.75 g/ha, 7.5 g/ha or 75 g/ha of copper metal.

In some embodiments, the combination, composition, and/or delivery system is applied at an amount of about 0.0052 g/ha of copper metal. In some embodiments, the combination, composition, and/or delivery system is applied at an amount of about 0.001 g/ha of copper metal. In some embodiments, the combination, composition, and/or delivery system is applied at an amount of about 0.059 g/ha of copper metal. In some embodiments, the combination, composition, and/or delivery system is applied at an amount of about 0.0095 g/ha of copper metal.

In some embodiments, the combination, composition, and/or delivery system is applied at an amount of about 15 g/ha of copper metal. In some embodiments, the combination, composition, and/or delivery system is applied at an amount of about 150 g/ha of copper metal. In some embodiments, the combination, composition, and/or delivery system is applied at an amount of about 375 g/ha of copper metal. In some embodiments, the combination, composition, and/or delivery system is applied at an amount of about 450 g/ha of copper metal. In some embodiments, the combination, composition, and/or delivery system is applied at an amount of about 750 g/ha of copper metal.

A composition, combination, macromolecular complex and/or delivery system according to the invention is suitable for the control of pests that are encountered in horticulture, agriculture, and forestry. The macromolecular complexes are active against normally sensitive and resistant pest species and during all or individual stages of development. Prior to use, a composition comprising a macromolecular complex according to the invention is preferably dissolved or dispersed in water, or diluted with water, to provide an aqueous composition comprising between 0.001 and 10 w/v % of the copper-based fungicide. If required, an agriculturally acceptable carrier such as a sticking agent is added to the diluted aqueous composition.

A composition according to the invention is preferably diluted 2-5000 times, preferably about 200 times, with an aqueous solvent, preferably water, to contain between 0.0001 and 10% (w/v) of the copper-based fungicide, prior to contacting a plant, plant part or soil with the composition.

To control agricultural pests, the invention provides a use of a composition comprising a macromolecular complex according to the invention for the protection of a plant, or a part of a plant, against a pathogen. In order to achieve this effect, said plant or plant part, or a soil, is contacted with said composition, including a diluted aqueous composition.

Said composition is used, for example, to control powdery mildew and downy mildew infections on food/feed crops, including tree fruits, vegetable crops, field crops, grapes, ornamental plants, and sod farms. Further use, for example, is to control scab, including common scab, apple scab and black scab on potatoes, pear scab, and powdery scab, brown rot of peaches, currant and gooseberry leaf spot, peanut leafspot, and mildew on roses. Other uses include protection of greenhouse grown flowers and ornamentals, home vegetable gardens and residential turf. In addition, said composition, including a diluted aqueous composition, may be contacted with isolated fruits, nuts, vegetables, and/or flowers.

For said use and said methods, the composition, including a diluted aqueous composition, is preferably sprayed over a plant, or part thereof. Spraying applications using automatic systems are known to reduce labor costs and are cost-effective. Methods and equipment well-known to a person skilled in the art can be used for that purpose. The composition, including diluted aqueous composition, can be regularly sprayed, when the risk of infection is high. When the risk of infection is lower, spray intervals may be longer.

Other methods suitable for contacting plants or parts thereof with a composition of the invention are also a part of the present invention. These include, but are not limited to, dipping, watering, drenching, introduction into a dump tank, vaporizing, atomizing, fogging, fumigating, painting, brushing, misting, dusting, foaming, spreading-on, packaging and coating (e.g. by means of wax or electrostatically). In addition, the composition, including a diluted aqueous composition, may be injected into the soil.

For example, a plant of part thereof may be coated with a diluted aqueous composition comprising a copper-based fungicide according to the invention by submerging the plant or part thereof in a diluted aqueous composition to protect the plant of part thereof against a pathogen and/or to prevent, reduce and/or eliminate the presence of a pathogen on a plant, or a part of a plant. A preferred part of a plant that is coated with a composition according to the invention, or with a dilution thereof, is seed. A further preferred part of a plant that is coated with a composition according to the invention, or with a dilution thereof, is leaf. A further preferred part of a plant that is coated with a composition according to the invention, or with a dilution thereof, is a fruit, preferably a post-harvest fruit such as, for example, a citrus fruit such as orange, mandarin and lime, a pome fruit such as apple and pear, a stone fruit such as almond, apricot, cherry, damson, nectarine, tomato, watermelon, a tropical fruit such as banana, mango, lychee and tangerine. A preferred fruit is a citrus fruit, such as orange and/or a tropical fruit such as banana.

The invention provides a method for (i) increasing biological activity of a copper-based fungicide on a target, (ii) increasing persistence of a copper-based fungicide into a target, (iii) increasing retention of a copper-based fungicide by a target, (iv) increasing absorbance of a copper-based fungicide by a target, and/or (v) increasing or enhancing bioavailability of a copper-based fungicide to a target, wherein the method comprises interacting the copper-based fungicide with a polyelectrolyte prior to application of the copper-based fungicide to a plant, a plant part, and/or soil.

In some embodiments, the method comprises interacting the copper-based fungicide with the polyelectrolyte through complexation by non-covalent electrostatic interaction prior to application of the copper-based fungicide to the plant, plant part, and/or soil.

In some embodiments, the method comprises interacting the copper-based fungicide with the polyelectrolyte to form a macromolecular complex prior to application of the copper-based fungicide to the plant, plant part, and/or soil.

In some embodiments, the method comprises complexing, entrapping, or encapsulating the copper-based fungicide partially or completely within the polyelectrolyte prior to application of the copper-based fungicide to the plant, plant part, and/or soil. In some embodiments, the method comprises entrapping the copper-based fungicide partially or completely within the polyelectrolyte prior to application of the copper-based fungicide to the plant, plant part, and/or soil.

The invention provides the use of a macromolecular complex, a composition or a delivery system of the present invention for (i) increasing biological activity of a copper-based fungicide on a target, (ii) increasing uptake of a copper-based fungicide into a target, (iii) increasing retention of a copper-based fungicide by a target, (iv) increasing absorbance of a copper-based fungicide by a target, and/or (v) increasing or enhancing bioavailability of a copper-based fungicide to a target.

In some embodiments, the bioavailability of the copper-based fungicide is increased or enhanced by controlling the release rate of the copper ion from the copper-based fungicide.

In some embodiments, the target is a plant. In some embodiments, the target is a plant part. In some embodiments, the target is a fungus.

The invention provides a method for (i) reducing drift of a copper-based fungicide, (ii) increasing leaf adhesion of a copper-based fungicide, (iii) increasing rainfastness of a copper-based fungicide, (iv) increasing persistence of a copper-based fungicide, and/or (v) reducing phytotoxicity of a copper-based fungicide, wherein the method comprises interacting the copper-based fungicide with a polyelectrolyte prior to application of the copper-based fungicide.

In some embodiments, the method comprises interacting the copper-based fungicide with a polyelectrolyte through complexation by non-covalent electrostatic interaction.

In some embodiments, the method comprises interacting the copper-based fungicide with a polyelectrolyte to form a macromolecular complex.

The invention provides the use of a macromolecular complex, a composition or a delivery system of the present invention for (i) reducing drift of a copper-based fungicide, (ii) increasing leaf adhesion of a copper-based fungicide, (iii) increasing rainfastness of a copper-based fungicide, and/or (iv) increasing persistence of a copper-based fungicide.

The invention also provides a method for reducing phytotoxicity of a copper-based fungicide on a plant, comprising interacting the copper-based fungicide with a polyelectrolyte through complexation by intermolecular electrostatic interactions prior to application of the copper-based fungicide to a plant, part of a plant and/or soil.

An aspect of the invention provides a use of the macromolecular complex, composition, and/or delivery system according to the invention, comprising a copper-based fungicide and a polyelectrolyte, for increasing biological activity of the copper-based fungicide.

An aspect of the invention provides a use of the polyelectrolyte, for increasing biological activity of the copper-based fungicide.

An aspect of the invention provides a use of the polyelectrolyte, for decrease the application rate of the copper-based fungicide.

An aspect of the invention provides a use of the polyelectrolyte for controlling the bioavailability of the copper-based fungicide by controlling the release profile of copper ion from the copper-based fungicide.

The present invention also provides a method for decreasing phytotoxicity of the copper-based fungicide comprising interacting the fungicide with a polyelectrolyte through complexation by intermolecular electrostatic interactions prior to application of the fungicide to a plant, part of a plant and/or soil.

The present invention also provides a method for decreasing the phytotoxicity of the copper-based fungicide comprising formulating the copper-based fungicide with a polyelectrolyte.

The present invention also provides a method for increasing biological activity of a copper-based fungicide on a fungus comprising interacting the copper-based fungicide with a polyelectrolyte through complexation by intermolecular electrostatic interactions prior to application of the copper-based fungicide to a plant, part of a plant and/or soil.

The present invention also provides a method for increasing fungicidal activity of a copper-based fungicide on a fungus comprising interacting the copper-based fungicide with a polyelectrolyte through complexation by intermolecular electrostatic interactions prior to application of the copper-based fungicide to a plant, part of a plant and/or soil.

The present invention also provides a method for increasing uptake of a copper-based fungicide by a target, comprising interacting the copper-based fungicide with a polyelectrolyte through complexation by intermolecular electrostatic interactions prior to application of the copper-based fungicide to a plant, part of a plant and/or soil.

The present invention also provides a method for increasing uptake of a copper-based fungicide by a target, comprising interacting the copper-based fungicide with a polyelectrolyte through complexation by intermolecular electrostatic interactions prior to application of the copper-based fungicide to a plant, part of a plant and/or soil.

The invention also provides a method for reducing drift of a copper-based fungicide comprising interacting the copper-based fungicide with a polyelectrolyte to form a macromolecular complex, preferably by complexing or entrapping the copper-based fungicide partially or completely within the polyelectrolyte, prior to application of the copper-based fungicide to a plant, plant part, and/or soil.

The invention also provides a method for increasing leaf adhesion of a copper-based fungicide comprising interacting the copper-based fungicide with a polyelectrolyte to form a macromolecular complex, preferably by complexing or entrapping the copper-based fungicide partially or completely within the polyelectrolyte, prior to application of the copper-based fungicide to a plant, plant part, and/or soil.

The invention also provides a method for increasing rainfastness of a copper-based fungicide comprising interacting the copper-based fungicide with a polyelectrolyte to form a macromolecular complex, preferably by complexing or entrapping the copper-based fungicide partially or completely within the polyelectrolyte, prior to application of the copper-based fungicide to a plant, plant part, and/or soil.

The invention also provides a method for increasing persistence of copper-based fungicide comprising interacting the copper-based fungicide with a polyelectrolyte to form a macromolecular complex, preferably by complexing or entrapping the copper-based fungicide partially or completely within the polyelectrolyte, prior to application of the copper-based fungicide to a plant, plant part, and/or soil.

In some embodiments, the target is a plant. In some embodiments, the target is a pest. In some embodiments, the pest is a fungus.

The present invention also provides a method for increasing bioavailability of a copper-based fungicide comprising interacting the copper-based fungicide with a polyelectrolyte by complexing the copper-based fungicide with the polyelectrolyte or entrapping or encapsulating the copper-based fungicide within the polyelectrolyte prior to application of the copper-based fungicide to a plant, part of a plant and/or soil.

The present invention also provides a method for increasing the biological activity of a copper-based fungicide on a pest comprising interacting the copper-based fungicide with a polyelectrolyte through complexation by intermolecular electrostatic interactions prior to application of the copper-based fungicide to a plant, part of a plant and/or soil.

The term “increasing biological activity” refers to curative, knock down, preventive and/or persistence performance.

The present invention also provides a method for increasing uptake of a copper-based fungicide by a target, comprising interacting the copper-based fungicide with a polyelectrolyte through complexation by intermolecular electrostatic interactions prior to application of the copper-based fungicide to a plant, part of a plant and/or soil.

In some embodiments, the target is a plant. In some embodiments, the target is a pest. In some embodiments, the pest is a fungus.

The present invention also provides a method for increasing absorbance of a copper-based fungicide by a plant tissue, comprising interacting the copper-based fungicide with a polyelectrolyte through complexation by intermolecular electrostatic interactions prior to application of the copper-based fungicide to a plant, part of a plant and/or soil.

The present invention also provides a method for increasing biological activity of a copper-based fungicide on a pest comprising interacting the copper-based fungicide with a polyelectrolyte through complexation by intermolecular electrostatic interactions prior to application of the copper-based fungicide to a plant, part of a plant and/or soil.

The present invention also provides a method for increasing the uptake of copper-based fungicide by a plant, comprising interacting the copper-based fungicide with a polyelectrolyte through complexation by intermolecular electrostatic interactions prior to application of the copper-based fungicide to the plant, part of a plant and/or soil.

The present invention also provides a method for increasing the bioavailability of a copper-based fungicide, comprising interacting the copper-based fungicide with a polyelectrolyte by complexing, entrapping or encapsulating molecules of the copper-based fungicide with or within molecules of the polyelectrolyte prior to application of the copper-based fungicide to a plant, part of a plant and/or soil.

The present invention also provides a method for increasing the biological activity of a copper-based fungicide on a plant comprising interacting the copper-based fungicide with a polyelectrolyte through non-covalent electrostatic interaction prior to application of the copper-based fungicide to a plant, part of a plant and/or soil.

The present invention also provides a method of increasing uptake of a copper-based fungicide by a plant, increasing retention of a copper-based fungicide by a plant and/or increasing bioavailability of a copper-based fungicide to a plant comprising interacting the copper-based fungicide with a polyelectrolyte through complexation by non-covalent electrostatic interaction prior to application of the copper-based fungicide to the plant, part of a plant and/or soil.

The present invention also provides a method for increasing the biological activity of a copper-based fungicide on a plant comprising interacting the copper-based fungicide with a polyelectrolyte through complexation by electrostatic intermolecular interaction prior to application of the copper-based fungicide to a plant, and/or soil.

The present invention also provides a method of increasing uptake of a copper-based fungicide by a plant, increasing retention of a copper-based fungicide by a plant and/or increasing bioavailability of a copper-based fungicide to a plant comprising interacting the copper-based fungicide with a polyelectrolyte through complexation by electrostatic intermolecular interaction prior to application of the copper-based fungicide to the plant, part of a plant and/or soil.

The method preferably comprises interacting the copper-based fungicide with the polyelectrolyte through non-covalent electrostatic interaction prior to the application.

The invention provides the use of a complex according to the invention for decreasing the application rate of a copper-based fungicide.

The invention provides the use of a macromolecular complex according to the invention for decreasing the application rate of a copper-based fungicide

The invention provides the use of a complex according to the invention for increasing the biological activity of a copper-based fungicide.

The invention provides the use of a macromolecular complex according to the invention for increasing the biological activity of a copper-based fungicide.

The present invention also provides a method for increasing the bioavailability of a copper-based fungicide, comprising interacting the copper-based fungicide with a polyelectrolyte by complexing, entrapping or encapsulating molecules of the copper-based fungicide entirely or partially within molecules of the polyelectrolyte prior to application of the copper-based fungicide to a plant, part of a plant and/or soil.

The invention provides the use of a complex according to the invention for enhancing the biological activity of a copper-based fungicide.

The invention provides the use of a macromolecular complex according to the invention for enhancing the biological activity of a copper-based fungicide.

The present invention also provides a method for enhancing the bioavailability of a copper-based fungicide, comprising interacting the copper-based fungicide with a polyelectrolyte by complexing, entrapping or encapsulating molecules of the copper-based fungicide entirely or partially within molecules of the polyelectrolyte prior to application of the copper-based fungicide to a plant, part of a plant and/or soil.

The invention provides the use of a macromolecular complex according to the invention for prolonging the fungicidal effect of a copper-based fungicide.

The use of at least one polyelectrolyte for formulating an aqueous suspension concentrate comprising copper-based fungicide.

The use of at least one dispersant and macromolecular complex for formulating an aqueous suspension concentrate comprising copper-based fungicide.

The use of at least one dispersant and macromolecular complex for formulating an aqueous suspension concentrate comprising a copper-based fungicide.

In some embodiments, molecules of the copper-based fungicide are entirely complexed with molecules of the polyelectrolyte by electrostatic interaction prior to application. In some embodiments, molecules of the copper-based fungicide are entirely complexed with molecules of the polyanion by electrostatic interaction prior to application In some embodiments, molecules of the copper-based fungicide are partially complexed with molecules of the polyelectrolyte prior to application. In some embodiments, molecules of the copper-based fungicide are partially complexed with molecules of the polyanion prior to application.

In some embodiments, molecules of the copper-based fungicide are entirely entrapped within the polyelectrolyte to form a macromolecular complex prior to application. In some embodiments, molecules of the copper-based fungicide are entirely entrapped within the polyanion to form a macromolecular complex prior to application In some embodiments, molecules of the bioactive ingredient which is copper-based fungicide are partially entrapped within the polyanion to form a macromolecular complex prior to application. In some embodiments, molecules of the bioactive ingredient which is copper-based fungicide are partially entrapped within the polyelectrolyte to form a macromolecular complex prior to application.

In some embodiments, molecules of the copper-based fungicide are entirely entrapped within the polyelectrolyte to form a macromolecular complex prior to application. In some embodiments, molecules of the copper-based fungicide are entirely entrapped within the polyanion to form a macromolecular complex prior to application. In some embodiments, molecules of the bioactive ingredient which is copper-based fungicide are partially entrapped within the polyanion to form a macromolecular complex prior to application. In some embodiments, molecules of the bioactive ingredient which is copper-based fungicide are partially entrapped within the polyelectrolyte to form a macromolecular complex prior to application.

The present invention also provides a method for pest control a plant disease caused

In some embodiments, at least 20% of the molecules of the copper-based fungicide are complexed by electrostatic interaction with the molecules of the polyelectrolyte prior to application. In some embodiments, at least 20% of the molecules of the copper-based fungicide are within the polyelectrolyte to form the complex prior to application.

The present invention also provides a method for pest control by preventive, curative or persistence treatments of a plant disease caused by phytopathogenic fungi comprising contacting a plant, a locus thereof or propagation material thereof with an effective amount of any one of the combinations, compositions, complexes or delivery system disclosed herein.

The present invention also provides a method for pest control by preventive, curative and/or persistence treatment of a plant disease caused by phytopathologic fungi comprising contacting a plant, a locus thereof or propagation material thereof with an effective amount of any one of the herein disclosed macromolecular complexes comprising a copper-based fungicide.

The invention provides the use of a complex according to the invention for increasing uptake of a copper-based fungicide into a plant, increasing retention of a copper-based fungicide by a plant and/or increasing the bioavailability of a copper-based fungicide to a plant.

The invention provides the use of a macromolecular complex according to the invention for increasing uptake of a copper-based fungicide, into a plant, increasing retention of a copper-based fungicide by a plant and/or increasing the bioavailability of a copper-based fungicide to a plant.

The invention also provides the use of a polyelectrolyte for decreasing phytotoxicity of a copper-based fungicide.

The described (macromolecular) complexes, compositions and/or delivery systems may be applied to healthy or diseased plants. The described (macromolecular) complexes, compositions and/or delivery systems can be used on various plants including but not limited to crops, seeds, bulbs, propagation material, or ornamental species.

The present invention provides a method of controlling a disease caused by phytopathogenic fungi on plants or propagation material thereof, comprising contacting the plants, the locus thereof or propagation material thereof with at least one of the herein defined combination, matrix, compositions or delivery systems.

The present invention provides a method for increasing the bioavailability of a copper-based fungicide, comprising interacting the copper-based fungicide with a polyelectrolyte to form a macromolecular matrix prior to application of the copper-based fungicide to a plant, plant part, and/or soil.

In some embodiments, the polyelectrolyte interacts with the copper-based fungicide by entrapping the copper-based fungicide partially or completely within the polyelectrolyte.

In some embodiments, the polyelectrolyte interacts with the copper-based fungicide by complexing or encapsulating the copper-based fungicide partially or completely within the polyelectrolyte.

The present invention provides use of any one of the combination, compositions described herein for the protection of a plant, or a part of a plant, against a pathogen.

In some embodiments, the composition is sprayed over a plant or a part of a plant.

In some embodiments, the plant part is leaf, seed or/and fruit.

In some embodiments, the combination, matrix, macromolecular complex or composition is applied at an amount of 0.01-2 g/ha of the copper-based fungicide.

The present invention also provides a method of protecting a plant, or a part of a plant, against a pathogen, comprising contacting said plant, or part of said plant, with any one or any combination of the compositions described herein.

The present invention also provides a method of preventing, reducing and/or eliminating the presence of a pathogen on a plant, or a part of a plant, comprising contacting said plant, or part of said plant, with any one of the compositions described herein.

In some embodiments, the plant part is leaf, seed or/and fruit.

The present invention also provides a method of controlling diseases caused by phytopathogenic fungi in plants or on propagation material thereof which comprises contacting the plants, or propagation material thereof, with any one or any combination the compositions described herein.

The present invention also provides a method for reducing drift of a copper-based fungicide comprising interacting the copper-based fungicide with a polyelectrolyte to form a macromolecular complex prior to application of the copper-based fungicide to a plant, plant part, and/or soil.

The present invention also provides a method for increasing rainfastness of a copper-based fungicide comprising interacting the copper-based fungicide with a polyelectrolyte to form a macromolecular complex prior to application of the copper-based fungicide to a plant, plant part, and/or soil. The present invention also provides a method for increasing persistence of a copper-based fungicide comprising interacting the copper-based fungicide with a polyelectrolyte to form a macromolecular complex prior to application of the copper-based fungicide to a plant, plant part, and/or soil.

In some embodiments, the fungus is one of Leaf Blotch of Wheat (Mycosphaerella graminicola; anamorph: Septoria tritici), Wheat Brown Rust (Puccinia triticina), Stripe Rust (Puccinia striiformis f. sp. tritici), Scab of Apple (Venturia inaequalis), Blister Smut of Maize (Ustilago maydis), Powdery Mildew of Grapevine (Uncinula necator), Barley scald (Rhynchosporium secalis), Blast of Rice (Magnaporthe grisea), Rust of Soybean (Phakopsora pachyrhizi), Glume Blotch of Wheat (Leptosphaeria nodorum), Powdery Mildew of Wheat (Blumeria graminis f. sp. tritici), Powdery Mildew of Barley (Blumeria graminis f. sp. hordei), Powdery Mildew of Cucurbits (Erysiphe cichoracearum), Anthracnose of Cucurbits (Glomerella lagenarium), Leaf Spot of Beet (Cercospora beticola), Early Blight of Tomato (Alternaria solani), and Net Blotch of Barley (Pyrenophora teres).

In some embodiments, the macromolecular complex, composition and/or delivery system according to the invention is applied as a foliar application.

In some embodiments, the macromolecular complex, composition and/or delivery system according to the invention is applied as a soil application.

In some embodiments, the pesticide is applied at a rate effective for controlling a pest. In some embodiments, the pesticide is applied at a rate effective for preventing infestation of the pest. In some embodiments, the pesticide is applied at a rate effective for curing infestation of the pest.

In some embodiments, a method of the invention is effective for preventing infestation of a pest. In some embodiments, the method is effective for curing infestation of the pest. In some embodiments, the method is effective for increasing the pesticidal activity of the copper-based fungicide. In some embodiments, the method is effective for prolonging the pesticidal effect of the copper-based fungicide. In some embodiments, the method is effective for increasing uptake of the pesticide by the plant, increasing retention of the copper-based fungicide by the plant, and/or increasing the bioavailability of the copper-based fungicide to the plant.

In some embodiments, a method of the invention is effective for decreasing the half maximal effective concentration (EC50) of the copper-based fungicide. In some embodiments, the method is effective for decreasing the EC50 by at least 10%. In some embodiments, the method is effective for decreasing the EC50 by at least 25%. In some embodiments, the method is effective for decreasing the EC50 by at least 35%. In some embodiments, the method is effective for decreasing the EC50 by at least 50%.

In some embodiments, a method of the invention is effective for decreasing the LC50 of the copper-based fungicide. In some embodiments, the method is effective for decreasing the LC50 by at least 10%. In some embodiments, the method is effective for decreasing the LC50 by at least 25%. In some embodiments, the method is effective for decreasing the LC50 by at least 50%. In some embodiments, the method is effective for decreasing the LC50 by at least 75%. In some embodiments, the method is effective for decreasing the LC50 by at least 90%.

In some embodiments, a method of the invention is effective for decreasing the LC90 of the copper-based fungicide. In some embodiments, the method is effective for decreasing the LC90 by at least 10%. In some embodiments, the method is effective for decreasing the LC90 by at least 25%. In some embodiments, the method is effective for decreasing the LC90 by at least 50%. In some embodiments, the method is effective for decreasing the LC90 by at least 75%. In some embodiments, the method is effective for decreasing the LC90 by at least 90%.

In some embodiments, a method of the invention further comprises applying at least one additional agrochemical to a pest, a plant part, a plant, the locus, or propagation material thereof.

In some embodiments, a macromolecular complex, composition or delivery system is tank mixed with an additional agrochemical. In some embodiments, the macromolecular complex, composition or delivery system is applied sequentially with the additional agrochemical. In some embodiments, the macromolecular complex, composition or delivery system is applied simultaneously with the additional agrochemical.

In some embodiments, the macromolecular complex, composition or delivery system is tank mixed with an additional adjuvant. In some embodiments, the macromolecular complex, composition or delivery system is applied sequentially with an additional adjuvant.

In some embodiments, the adjuvant is selected from group consisting of plant oil derivatives. In some embodiments, the plant oil derivative is a vegetable oil derivative. In some embodiments, the vegetable oil derivative is a soybean oil methyl ester.

In some embodiments, the combination, macromolecular complex, composition or delivery system is tank mixed with an additional agrochemical. In some embodiments, the macromolecular complex, composition or delivery system is applied sequentially with the additional agrochemical. In some embodiments, the macromolecular complex, composition or delivery system is applied simultaneously with the additional agrochemical.

### Processes for Preparation

The present invention provides a process for preparation of a composition comprising a macromolecular complex comprising copper-based fungicides and polyelectrolyte, the process comprising preparing a solution of the antifreeze in water, adding the polyanion and polycation to form the polyelectrolyte complex, adding the dispersant and wetter, adding the copper-based fungicide, adding 80% of the antifoam agent, milling of the formulation to the desired particle size range, adding the remaining 20% of the antifoam agent, adding a solution of the rheology modifying agent in water and stirring until an homogeneous mixture is obtained.

The present invention provides a process for preparation of a composition comprising a macromolecular complex comprising copper-based fungicides and polyelectrolyte, the process comprising preparing a solution of antifreeze in water, adding the polyanion, adding the dispersant and wetter, adding the copper-based fungicide.

The present invention provides a process for preparation of a composition comprising a macromolecular complex comprising copper-based fungicides and polyelectrolyte, the process comprising preparing a solution of an antifreeze in water, adding the polyanion, adding the dispersant and wetter, adding the copper-based fungicide, adding 80% of the antifoam agent, milling of the formulation to the desired particle size range, adding the remaining 20% of the antifoam agent, adding a solution of the rheology modifying agent in water and stirring until an homogeneous mixture is obtained.

In some embodiments, the process comprises preparing a solution of the antifreeze in water, adding only the polyanion to the copper-based fungicide to form the macromolecular complex, adding the dispersant and wetter, adding 80% of the antifoam agent, milling of the formulation to the desired particle size range, adding the remaining 20% of the antifoam agent, adding a solution of the rheology modifying agent in water and stirring until an homogeneous mixture is obtained.

In some embodiments, the macromolecular complex is made by pre-mixing the polyelectrolyte and the copper-based fungicide prior to addition of the other additives, dispersant, wetter, antifoam, and rheology modifying agent.

In some embodiments, the macromolecular complex is made by premixing the polyelectrolyte with the dispersants prior to the addition of the cooper-based fungicide.

The invention provides a process for producing a macromolecular complex of the present invention, comprising the following steps:
(a) providing an aqueous composition of a polyelectrolyte,
(b) mixing a copper-based fungicide into the aqueous composition, and
(c) thereby producing a macromolecular complex of a polyelectrolyte and a copper-based fungicide in an aqueous composition.

In some embodiments, the process further comprises a step of milling or grinding the resultant macromolecular complex to reduce their particle size to any of the particle sizes described herein.

In some embodiments, the process further comprises milling or grinding the resultant macromolecular complex to reduce their particle size such that the particles have a d90 of 10 microns or less and a d50 of 5 microns or less.

The invention provides a process for producing a combination or composition described herein by mixing the macromolecular complex as described herein with at least one agriculturally acceptable additive.

In some embodiments, the macromolecular complex is made by pre-mixing the polyelectrolyte and the copper-based fungicide prior to addition of the other additive.

In some embodiments, the surfactants are added before adding the active ingredients.

In some embodiments, the composition comprises at least one additional fungicide.

The present invention provides a process for preparation of a composition comprising (1) a macromolecular complex comprising copper-based fungicides and polyelectrolyte and (2) an additional fungicide(s), the process comprising preparing a solution of antifreeze in water, adding the polyanion and polycation to form the polyelectrolyte complex, adding the dispersant and wetter, adding the copper-based fungicide, wherein the additional fungicide is added any time after the addition of the copper based fungicide.

The present invention provides a process for preparation of a composition comprising (1) a macromolecular complex comprising copper-based fungicides and a polyelectrolyte and (2) an additional fungicide(s), the process comprising preparing a solution of the antifreeze in water, adding a polyanion and a polycation to form the polyelectrolyte complex, adding the dispersant and wetter, adding the copper-based fungicide, adding 80% of the antifoam agent, milling of the formulation to the desired particle size range, adding the remaining 20% of the antifoam agent, adding a solution of the rheology modifying agent in water and stirring until an homogeneous mixture is obtained, wherein the additional fungicide is added any time after the addition of the copper based fungicide. In some embodiments, the process comprises preparing a solution of the antifreeze in water, adding only the polyanion to the copper-based fungicide to form the macromolecular complex, adding the dispersant and wetter, adding 80% of the antifoam agent, milling of the formulation to the desired particle size range, adding the remaining 20% of the antifoam agent, adding a solution of the rheology modifying agent in water and stirring until an homogeneous mixture is obtained, wherein the additional fungicide is added any time after the addition of the copper-based fungicide.

The present invention provides a process for preparation of a composition comprising macromolecular complex comprising copper-based fungicides and polyelectrolyte, the process comprising preparing a solution of the antifreeze in water, adding the polyanion, adding the dispersant and wetter, adding the copper-based fungicide, wherein the additional fungicide is added any time after the addition of the copper based fungicide.

The present invention provides a process for preparation of a composition comprising a macromolecular complex comprising copper-based fungicides and polyelectrolyte, the process comprising preparing a solution of antifreeze in water, adding a polyanion, adding dispersant and wetter, adding the copper-based fungicide, adding 80% of the antifoam agent, milling of the formulation to the desired particle size range, adding the remaining 20% of the antifoam agent, adding a solution of a rheology-modifying agent in water and stirring until a homogeneous mixture is obtained, wherein the additional fungicide is added any time after the addition of the copper-based fungicide.

The present invention provides a process for preparation of a composition comprising (1) a macromolecular complex comprising copper-based fungicides and a polyelectrolyte and optionally (2) at least one additional fungicide, the process comprising preparing a solution of antifreeze in water, adding a polyanion and a polycation to form the polyelectrolyte complex, adding dispersant and wetter, and adding the copper-based fungicide.

The present invention provides a process for preparation of a composition comprising (1) a macromolecular complex comprising copper-based fungicides and a polyelectrolyte and optionally (2) at least one addition fungicide, the process comprising preparing a solution of antifreeze in water, adding the polyanion, adding dispersant and wetter, and adding the copper-based fungicide.

In some embodiments, when the composition further comprises a water immiscible carrier (SE), the process further comprises mixing with an emulsifiable concentrate (EC) comprising the additional fungicide.

In some embodiments, the emulsifiable concentrate (EC) comprises a solution of azole, strobilurion and/or any other fungicide different from copper based fungicide in a water immiscible carrier.

In some embodiments, the organic phase includes at least one water immiscible carrier.

In some embodiments, the water immiscible carrier is fatty acid amide.

In some embodiments, the organic phase includes at least one water immiscible carrier such as Armid DM10.

### Copper-Based Fungicide

In some embodiments, the copper-based fungicide is selected from the group consisting of copper hydroxide, copper oxychloride (tribasic), copper sulfate, copper gluconate, cuprous oxide, and any combination thereof.

In some embodiments, the copper-based fungicide is copper oxide. In some embodiments, the copper-based fungicide is copper oxychloride.

In some embodiments, the copper-based fungicide is CuSO₄∘Cu(OH)₂∘3CaSO₄ (equivalent to 66 g/L of Copper) (Bordeaux).

### Polyelectrolyte

Polyelectrolyte in the present application refer to polyanion and/or complex of poyanion and polycation.

Many different polyanions of both natural origin, for example xanthan gum, alginate, pectin, a lignin compound such as lignosulfonate, carrageenan, humic acid, fulvic acid, angico gum, gum Kondagogu, sodium alkyl naphtalene sulfonate, poly-γ-glutamic acid, maleic starch half-ester, carboxymethyl cellulose, chondroitin sulphate, dextran sulphate, and hyaluronic acid, and synthetic origin, for example poly(acrylic acid), polyphosphoric acid, and poly(L-lactide). Most preferably, said polyanion comprises or is lignosulfonate. The term “lignin compound” refers to a chemical compound that is derived from naturally occurring lignin or lignen by a process that includes sulphonation. The resulting sulfonic acids are strong acids and lignin compounds are therefore negatively charged at pH values below 7.

The polyelectrolyte as polyanion can be a mixture of two or more polyanions.

The polyelectrolyte as polyanion can be a mixture of two or more lignin compounds.

A preferred lignin compound is selected from Kraft lignin, organosolv lignin and/or lignosulfonate. A Kraft lignin is a polyphenols product from the Kraft pulping process for the conversion of wood into wood pulp. Included are derivatives from Kraft lignin obtained by oxidation or other chemical modification as is known to the skilled person.

An organosolv lignin is a polyphenolic product from delignification processes using organic solvents. Included are derivatives from organosolv lignin obtained by oxidation or other chemical modification as is known to the skilled person.

Lignosulfonate (also termed lignosulphonate, lignosulfate, lignin sulfonate, ligninsulfonate, ligninsulfonic acid, lignosulfonic acid, lignosulfuric acid, or LST 7) is a water-soluble anionic polymer which is, for example, formed as a by-product in the sulphite pulping process. Lignosulfonates generally have a wide molecular weight distribution, typically in the range of about 500 to about 150,000. Lignosulfonates may comprise different metal or ammonium ions as counter cations of the sulfonate groups such as, for example, copper, zinc, calcium, sodium, potassium, magnesium and aluminium. Suitable examples of lignosulfonates comprise sodium lignosulfonate (e.g. sold as BORRESPERSE NA®, Borregaard LignoTech Ltd, Germany), calcium lignosulfonate (e.g. sold as BORRESPERSE CA®, Borregaard LignoTech Ltd, Germany), ammonium lignosulfonate, potassium lignosulfonate, modified lignosulfonate, derivatives of lignosulfonate, or mixtures thereof. Modified lignosulfonates, and derivatives of lignosulfonates are described in U.S. Pat. Nos. 3,639,263, 3,923,532, 4,006,779, 4,017,475, 4,019,995, 4,069,217, 4,088,640, 4,133,385, 4,181,652, 4,186,242, 4,196,777, 4,219,471, 4,236,579, 4,249,606, 4,250,088, 4,267,886, 4,269,270, 4,293,342 4,336,189, 4,344,487, 4,594,168, 4,666,522, 4,786,438, 5,032,164, 5,075,402, 5,286,412, 5,401,718, 5,446,133, 5,981,433, 6,420,602, and 7,238,645, which are incorporated herein by reference. A preferred lignin compound is lignosulfonate. A preferred lignosulfonate is copper-, zinc-, calcium-, sodium-, potassium-, ammonium-, magnesium- and/or aluminium-lignosulfonate, preferably calcium, sodium, potassium or ammonium lignosulfonate, most preferred calcium lignosulfonate.

The term chitosan relates to linear p-(1→4)-linked glucosamin and N-acetylglucosamin. It may be produced from chitin or its sodium salt (e.g. originating from shrimp) by treatment with aqueous sodium hydroxide at elevated temperatures, or by enzymatic treatment with, for example, a chitin deacetylase (EC 3.5.1.41). Further sources of chitin are fungi, including Basidiomycetes, Ascomycetes, and Phycomycetes, where it is a component of cell walls and structural membranes of mycelia, stalks, and spores. A most preferred chitosan is from fungi or derived from fungi.

The preferred MW of chitosan is 10-20 kDa. Using chitosan from with a higher MW of 20-30 kDa can cause differences in the physicochemical properties of the resultant compositions such as increase in viscosity or formation of aggregates.

In some embodiments, wherein the polyelectrolyte is complex of polyanion and polycation, polycation is selected from the group consisting of poly-L-lysine, epsilon-poly-L-lysine, poly-L-arginine, chitosan oligosaccharide, and chitosan. Most preferably, said polycation comprises or is chitosan. Typically, deacetylation as determined by colloidal titration is from 50 to 99.9%, preferably from 70 to 99.8% and most preferably from 90 to 99.7%, as compared to chitin. Chitosan derivatives can be prepared by reactions at the amino group (e.g. by N-acylation, formation of N-alkylidene and N-arylidene derivatives, N-alkylation and N-arylation) or at hydroxy groups, as is known to the skilled person.

A polycation preferably is or comprises cationic starch, poly(allylamine), chitosan, a chitosan derivative such as thiolated chitosan, 5-methyl-pyrrolidinone-chitosan, and chitosan oligosaccharide, epsilon-p-L-lysine, DEAE-dextran, or mixtures thereof, to form a polyelectrolyte complex with polyanion. Preferably, said polycation is selected from the group consisting of cationic starch, poly(allylamine), chitosan and chitosan derivatives. Preferably, said polycation is poly(allylamine). Preferably, said non-bioactive polycation is chitosan. In some embodiments, the polycation is chitosan (CTS), epsilon-poly-L-lysine (c-PLL), poly allyl amine (PAA), or any combination thereof. In some embodiments, the polycation is chitosan (CTS). In some embodiments, the polycation is poly allyl amine (PAA). In some embodiments, the polycation is epsilon-poly-L-lysine (c-PLL).

As used herein, the term “chitosan” refers to a linear polysaccharide composed of randomly distributed 6-(1-4)-linked D-glucosamine (deacetylated unit) and N-acetyl-D-glucosamine (acetylated unit). Chitosan is produced by deacetylation of chitin. The term “chitosan” relates to chitosan, chitosan derivatives and mixtures of chitosan and chitosan derivatives

The polyelectrolyte complex comprises a polyanion, such as a lignin-compound, xanthan gum and alginate, and a polycation, such as chitosan, in a relative amount of between 1:2 and 60:1 (w/w), more preferred between 1:1 and 50:1, more preferred between 2:1 and 30:1, such as about 6:1; about 5:1, about 4:1, (w/w). The relative amounts of polyanion, preferably a lignin compound, and a polycation, preferably chitosan, in a polyelectrolyte complex according to the invention is most preferred about 10:1, even more preferred about 5:1 (w/w).

In a watery solution at a pH of about 4.5, polycations such as chitosan polymers are positively charged and the cationic amino groups on the glucosamine subunits can interact electrostatically with anionic groups (usually carboxylic acid groups) of polyanions such as lignosulfonate to form polyelectrolyte complexes Polyelectrolyte can be complex of mixture of two or more polyanion with a mixture of two or more polycation.

Polyelectrolyte can be complex of mixture of two or more lignin compound with a mixture of two or more chitosan.

Each embodiment disclosed herein is contemplated as being applicable to each of the other disclosed embodiments. Thus, all combinations of the various elements described herein are within the scope of the invention. In addition, the elements recited in macromolecular complex embodiments can be used in the composition, method, use, process, delivery system embodiments described herein and vice versa.

The invention is illustrated by the following examples without limiting it thereby.

### EXPERIMENTAL SECTION

### Example 1—Copper-Based Fungicide-Polyelectrolyte Compositions

Polyelectrolyte, polyanion (A) and a complex of polyanion and polycation (B) were tested in the experiments described herein below: chitosan (CTS), lignosulfonate as polyelectrolytes, in combination with copper-based fungicide.

The general procedure for formulating copper-based fungicide-polyelectrolyte composition involves the following steps:
Addition of the antifreeze agent (for example propylene glycol) to the water
Addition of the polycation (for example chitosan)
Addition of the polyanion (for example calcium lignosulfonate)
Addition of the dispersant (for example Metasperse 500L) and wetter (for example Atlas G5002L) agents
Addition of copper-based fungicide
Addition of 80% of the antifoam agent (for example Silicolapse 426R)
Milling of the formulation to the desired particle size range
Addition of 20% of the antifoam agent (for example Silicolapse 426R)
Addition of a solution of the rheology modifying agent in water (for example xantham gum) and stirring until a homogeneous mixture is obtained

The general procedure for preparing a composition comprising copper-based fungicide and polyelectrolyte, wherein the polyelectrolyte is a complex of polycation and polyanion, is summarized in Table 1 below.

TABLE 1

| | | Stirring | | |
|---|---|---|---|---|
| Step | Process | time* | | Comment |
| 0 | Prepare xanthan gum 2% Rhodopol | 4+ | hours | |
| | 23 solution upfront in a separate | | | |
| | beaker for later use | | | |
| 1 | Add 1,2-Propandiol to water under | 5 | min | |
| | stirring (500-600 RPM) stir until | | | |
| | homogenously blended | | | |
| 2 | Add chitosan portion-wise until | 15 | min | |
| | completely dissolved | | | |
| 3 | Add CaLS portion-wise and stir until | 30 | min | |
| | lumps are below 1 mm diameter | | | |
| 4 | Add dispersant and wetter until a | 30 | min | |
| | homogenous mixture is obtain, ensure | | | |
| | Atlas G 5002 L is dissolved | | | |
| 5 | Slowly add active ingredient | 30 | min | Adjust |
| | (CuBM), shovel-wise - 1 shovel/5 | | | stirring |
| | min - total 6-7 shovels and stir | | | speed to |
| | afterwards for at least 30 min | | | reduce air |
| | | | | incorporation |
| 6 | Add 80% antifoam | 5 | min | |
| 7 | Mill the formulation until PSD is | 30-60 | min | Check the |
| | d50 < 3; d90 < 7; d99 < 20 | | | PSD graph |
| 8 | Add 20% antifoam | 5 | min | |
| 9 | Add xanthan gum under stirring and | 1+ | hour | |
| | mix until a homogenous mixture is | | | |
| | obtained | | | |

*Stirring times are indications for preparing 1 liter sample

The general procedure for preparing a composition comprising copper-based fungicide and polyelectrolyte, wherein the polyelectrolyte is a polyanion, is summarized in Table 2 below.

TABLE 2

| | | Stirring | | |
|---|---|---|---|---|
| Step | Process | time* | | Comment |
| 0 | Prepare xanthan gum 2% Rhodopol | 4+ | hours | |
| | 23 solution upfront in a separate | | | |
| | beaker for later use | | | |
| 1 | Add 1,2-Propanediol to water under | 5 | min | |
| | stirring (500-600 RPM) stir until | | | |
| | homogenously blended | | | |
| 2 | Add CaLS portion-wise and stir until | 30 | min | |
| | lumps are below 1 mm diameter | | | |
| 3 | Add 80% antifoam | 5 | min | |
| 4 | Add dispersant and wetter until a | 30 | min | |
| | homogenous mixture is obtain, ensure | | | |
| | Atlas G 5002 L is dissolved | | | |
| 5 | Slowly add active ingredient | 30 | min | Adjust |
| | (CuBM), shovel-wise - 1 shovel/5 | | | stirring |
| | min - total 6-7 shovels and stir | | | speed to |
| | afterwards for at least 30 min | | | reduce air |
| | | | | incorporation |
| 6 | Mill the formulation until PSD is | 10-30 | min | Check the |
| | d50 < 3; d90 < 7; d99 < 20 | | | PSD graph |
| 7 | Add 20% antifoam | 5 | min | |
| 8 | Add xanthan gum under stirring and | 1+ | hour | |
| | mix until a homogenous mixture is | | | |
| | obtained | | | |

*Stirring times are indications for preparing 1 liter sample

The following formulations summarized in Tables 3 and 4 were prepared using the general procedure of Table 1.

TABLE 3
DT-CE-C4-345-08T - a composition comprising copper-based fungicide
and polyelectrolyte, wherein the polyelectrolyte is a complex
of polycation and polyanion, with Croda surfactants

| Code | [g/L] | [w/w %] |
|---|---|---|
| Bordeaux mix | 345 | 28.8 |
| water | 645.4 | 53.8 |
| Chitosan | 5.6 | 0.5 |
| CaLS (Starlig-Ca) | 28 | 2.3 |
| Metasphere 500L | 24 | 2 |
| Atlas G5002L | 24 | 2 |
| Silicolapse 426R | 5 | 0.4 |
| propan 1,2 diol | 50 | 4.2 |
| acticide MBS | 1 | 0.083 |
| Rhodopol 23 (2% gel in water) | 72 | 6 |

TABLE 4
DT-CE-C4-345-09T - a composition comprising copper-based fungicide
and polyelectrolyte, wherein the polyelectrolyte is a complex
of polycation and polyanion, with Tensiofix surfactants

| Code | [g/L] | [%] |
|---|---|---|
| Bordeaux mix | 345 | 28.8 |
| water | 635.7 | 55 |
| Chitosan | 5.6 | 0.5 |
| CaLS (Starlig-Ca) | 28 | 2.3 |
| Tensiofix CGA213 | 12 | 1 |
| Tensiofix LB350 | 24 | 2 |
| Tensiofix L051 | 2.7 | 0.2 |
| propan 1,2 diol | 50 | 4.2 |
| acticide MBS | 1 | 0.083 |
| Rhodopol 23 (2% gel in | 96 | 6 |
| water) | | |

The following formulations summarized in Tables 5 and 6 were prepared using the general procedure of Table 2.

TABLE 5
DT-CE-C4-345-10T - a composition comprising copper-
based fungicide and polyelectrolyte, wherein the polyelectrolyte
is a polyanion, with Croda surfactants

| Code | [g/L] | [%] |
|---|---|---|
| Bordeaux mix | 345 | 28.8 |
| water | 627 | 52.3 |
| CaLS (Starlig-Ca) | 28 | 2.3 |
| Metasphere 500L | 24 | 2 |
| Atlas G5002L | 24 | 2 |
| Silicolapse 426R | 5 | 0.4 |
| propan 1,2 diol | 50 | 4.2 |
| acticide MBS | 1 | 0.083 |
| Rhodopol 23 (2% gel in | 96 | 8 |
| water) | | |

TABLE 6
DT-CE-C4-345-11T - a composition comprising copper-based
fungicide and polyelectrolyte, wherein the polyelectrolyte
is a polyanion, with Tensiofix surfactants

| Code | [g/L] | [%] |
|---|---|---|
| Bordeaux mix | 345 | 28.8 |
| water | 641.3 | 53.4 |
| CaLS (Starlig-Ca) | 28 | 2.3 |
| Tensiofix CGA213 | 12 | 1 |
| Tensiofix LB350 | 24 | 2 |
| Tensiofix L051 | 2.7 | 0.2 |
| propan 1,2 diol | 50 | 4.2 |
| acticide MBS | 1 | 0.083 |
| Rhodopol 23 (2% gel in | 96 | 8 |
| water) | | |

TABLE 7
Protocol CF1951 03. A composition comprising copper-based
fungicide Cu-oxychloride, Picoxystrobine, Prothioconazole
and polyelectrolyte (3.1%), wherein the polyelectrolyte is
a complex of polycation and polyanion at a ratio of 1:9.

| Ingredient | g/L | w/w % |
|---|---|---|
| Water | 500.6 | 35.8% |
| Propan-1,2-diol | 50.0 | 3.6% |
| Chitosan Bovlin | 4.36 | 0.3% |
| CaLS | 39.2 | 2.8% |
| Cu-oxychloride | 427.14 | 30.5% |
| Na citrate | 36.00 | 2.6% |
| Picoxystrobine (99.9) | 70.07 | 5.0% |
| Prothioconazole (99.3) | 80.56 | 5.8% |
| Tergitol XD | 70 | 5.0% |
| Ecosurf EH6 | 12 | 0.9% |
| Silcolapse 426R | 5 | 0.4% |
| Xanthan gum (2% Rhodopol23) | 105 | 7.5% |

TABLE 7a
The method of preparation for CF1951-03 composition comprising PEM copper-based fungicide Cu-
oxychloride, and additional fungicides Picoxystrobine, and Prothioconazole is as follows:

| | | Stirring | | |
|---|---|---|---|---|
| Step | Process | time *¹ | | Comment |
| 0 | Prepare upfront in a separate beaker for later use xanthan | 4+ | hours | mechanical stirrer |
| | gum 2% Rhodopol 23 solution | | | (500-2000 RPM) |
| 1 | Add 1,2 propanediol to water under stirring, blend | 5 | min | mechanical stirrer |
| | homogeneously | | | (500-600 RPM) |
| 2 | Add chitosan portion-wise until completely dissolved | 15 | min | |
| 3 | Add half of CaLS portion-wise and stir until lumps are | 10 | min | Dispersion becomes |
| | below 1 mm diameter | | | light beige |
| 4 | Add remaining CaLS and stir until lumps are below 1 mm | 20 | min | Dispersion becomes |
| | diameter | | | brown |
| 5 | Add Tergitol XD, Ecosurf EH6 and mix for 30 min | 30 | min | Adjust RPM to have |
| | | | | proper stirring |
| 6 | Add 80% of the Silcolapse 416 and mix for 5 minutes | 5 | min | |
| 7 | Add Cu-Oxychloride portion-wise (30 minutes) into the | 30 | min | |
| | solution and mix for an additional 10 minutes | | | |
| 8 | Check pH-value and add 20% of Na-citrate salt if needed | 10 | min | pH-value should be |
| | | | | 6.0-7.0 |
| 9 | Add Picoxystrobin, add Na-citrate if required | 15 | min | control pH and keep |
| | | | | between 6.0-7.0 |
| 10 | Add Prothioconazole | 15 | min | control pH and keep |
| | | | | between 6.0-7.0 |
| 11 | Check pH-value and add remaining citrate salt | 30 | min | control pH and keep |
| | | | | between 6.0-7.0 |
| 12 | Slurry is milled until PSD is d50 < 3; d90 < 7; check graph | 20 | min | Dispermat SL |
| | of PSD d99 < 20 | | | Zirkonium beads |
| | | | | 3000-4000 RPM |
| | | | | (100-300 W) |
| 13 | Transfer slurry after milling to normal stirrer | | | Mechanical stirrer |
| | | | | (500-1000 RPM) |
| 14 | Add 20% of Silcolapse 426R | 1 | min | |
| 15 | Add Xanthan gum pregel | 60 | min | |

TABLE 8
CF1901-04-07. A composition comprising copper-based fungicide
Bordeaux mixture, Picoxystrobine, Prothioconazole and polyelectrolyte
(1.2%), wherein the polyelectrolyte is a complex of polycation
and polyanion at a weight % ratio of 1:5.

| Ingredient | g/L | w/w % |
|---|---|---|
| Water | 556.3 | 41.2% |
| Propan-1,2-diol | 50.0 | 3.7% |
| Bolin - Chitosan | 3.36 | 0.2% |
| Acetic acid | 0 | 0% |
| Borreseperse CA - CaLS | 13.4 | 1.0% |
| Cu-BM (29.2% Cu) | 428.1 | 31.7% |
| Prothioconazole 99.3% | 40.0 | 3.0% |
| Picoxystrobin 99.9% | 35.0 | 2.6% |
| Sodium citrate | 8 | 1.5 |
| Soprophor FL | 100 | 7.4% |
| Atlas G5002L | 20 | 1.5% |
| Silcolapse 426R | 10 | 0.7% |
| Acticide MBS | 1.0 | 0.1% |
| Xanthan gum (2% Rhodopol 23) | 85 | 6.3% |

TABLE 8a
The method of preparation for CF1951-03 composition comprising PEM copper-based Bordeaux mixture
fungicide, and additional fungicides Picoxystrobine, and Prothioconazole is as follows:

| | | Stirring | | |
|---|---|---|---|---|
| Step | Process | time *¹ | | Comment |
| 0 | Prepare upfront in a separate beaker for later use | 4+ | hours | mechanical stirrer |
| | xanthan gum 2% Rhodopol 23 solution | | | (500-2000 RPM) |
| 1 | Add 1,2-propanediol to water under stirring, stir | 5 | min | mechanical stirrer |
| | until blended homogeneously | | | (500-600 RPM) |
| 2 | Add acetic acid^{*2} (ratio Chitosan:Acetic acid 1:0.6) | 5 | min | ~pH 3 |
| 3 | Add chitosan portionwise until completely | 15 | min | |
| | dissolved | | | |
| 4 | Add CaLS portionwise and stir until lumps are | >30 | min | |
| | below 1 mm diameter | | | |
| 5 | Add Soprophor FL ad Atlas G5002L and mix for | 30 | min | Adjust RPM to have |
| | 30 min | | | proper stirring |
| 6 | Add 80% of the Silcolapse 426R and mix for 5 | 5 | min | |
| | minutes | | | |
| 7 | Add CuBM portion-wise (30 minutes) into the | 30 | min | |
| | solution and mix for an additional 10 minutes | | | |
| 8 | Check pH-value and add buffer | 10 | min | pH-wise should be 6.0-7.0 |
| 9 | Add Picoxystrobin | 15 | min | |
| 10 | Add Prothioconazole | 15 | min | |
| 11 | Slurry is milled until PSD is d50 < 3; d90 < 7; check | 30-60 | min | Dispermat SL Zirkonium |
| | graph of PSD d99 < 20 | | | beads 3000-4000-RPM |
| | | | | (100-300 W) |
| 12 | Transfer slurry after milling to normal stirrer | | | Mechanical stirrer |
| | | | | (500-1000 RPM) |
| | Add 20% of Silcolapse 426R | 1 | min | |
| 13 | Add Acticide MBS | 1 | min | |
| 14 | Add Xanthan gum pregel | 60 | min | |

TABLE 9
CF1901-04-04. A composition comprising copper-based fungicide
Bordeaux mixture, Picoxystrobine, Prothioconazole and polyelectrolyte
(2.5%), wherein the polyelectrolyte is a complex of polycation
and polyanion at a weight % ratio of 1:5.3.

| Ingredient | g/L | w/w % |
|---|---|---|
| Water | 523.94 | 38.8% |
| Propan-1,2-diol | 50.0 | 3.7% |
| Kitogreen - Chitosan | 5.6 | 0.4% |
| Acetic acid | 3.36 | 0.2% |
| Borreseperse CA - CaLS | 28.0 | 2.1% |
| Cu-BM (29.2% Cu) | 428.1 | 31.7% |
| Prothioconazole 99.3% | 40.0 | 3.0% |
| Picoxystrobin 99.9% | 35.0 | 2.6% |
| Dipotassiumhydrogenphosphate | 20 | 1.5 |
| Soprophor FL | 100 | 7.4% |
| Atlas G5002L | 20 | 1.5% |
| Silcolapse 426R | 10 | 0.7% |
| Acticide MBS | 1.0 | 0.1% |
| Xanthan gum (2% Rhodopol 23) | 85 | 6.3% |

TABLE 10
CF1901-04-05. A composition comprising copper-based fungicide
Bordeaux mixture, Picoxystrobine, Prothioconazole and polyelectrolyte
(2.5%), wherein the polyelectrolyte is a complex of polycation
and polyanion at a weight % ratio of 1:4.

| Ingredient | g/L | w/w % |
|---|---|---|
| Water | 566.3 | 41.9% |
| Propan-1,2-diol | 50.0 | 3.7% |
| Bolin - Chitosan | 6.72 | 0.5% |
| Acetic acid | 0 | 0% |
| Borreseperse CA - CaLS | 26.9 | 2.0% |
| Cu-BM (29,2% Cu) | 428.1 | 31.7% |
| Prothioconazole 99.3% | 40.0 | 3.0% |
| Picoxystrobin 99.9% | 35.0 | 2.6% |
| Dipotassiumhydrogenphosphate | 20 | 1.5 |
| Soprophor FL | 100 | 7.4% |
| Atlas G5002L | 20 | 1.5% |
| Silcolapse 426R | 10 | 0.7% |
| Acticide MBS | 1.0 | 0.1% |
| Xanthan gum (2% Rhodopol 23) | 46 | 3.4% |

TABLE 11
CF1950-15-01. A composition comprising copper-based fungicide Cu-
oxychloride, fluopicolide and polyelectrolyte (4.0%), wherein the
polyelectrolyte is a complex of chitosan polycation and calcium
lignosulfonate (CaLS) polyanion at a weight % ratio of 1:9.

| CF1950-15-01 | | |
|---|---|---|
| Ingredients | g/L | w/w % |
| Water | 442.48 | 36.9% |
| Propan-1,2-diol | 50.0 | 4.2% |
| Chitosan | 4.36 | 0.4% |
| CaLS | 43.6 | 3.6% |
| Cu-oxychloride | 425.89 | 35.5% |
| Fluopicolide | 66.67 | 5.6% |
| Soprophor 3D33 | 30 | 2.5% |
| Ecosurf EH6 | 12 | 1.0% |
| Silcolapse 426R | 5 | 0.4% |
| Xanthan gum (2% Rhodopol 23) | 120 | 10.0% |
| Total | 1200 | 100.0% |

TABLE 11a
The method of preparation for CF1950-15-01 composition comprising PEM copper-based
fungicide Cu-oxychloride, and additional fluopicolide fungicide is as follows:

| | | Stirring | | |
|---|---|---|---|---|
| Step | Process | time *¹ | | Comment |
| 0 | Prepare upfront in a separate beaker for later use | 4+ | hours | mechanical stirrer |
| | xanthan gum 2% Rhodopol 23 solution | | | (500-2000 RPM) |
| 1 | Add 1,2-propanediol to water under stirring, stir | 5 | min | mechanical stirrer |
| | until blended homogeneously | | | (500-600 RPM) |
| 2 | Add 80% of the Silcolapse 426R and mix for 5 | 5 | min | |
| | minutes | | | |
| 3 | Add chitosan*² portionwise until completely | 15 | min | |
| | dissolved | | | |
| 4 | Add CaLS portionwise and stir until lumps are | 30 | min | |
| | below 1 mm diameter | | | |
| 5 | Add Cu-oxychloride portion-wise (30 minutes) into | 40 | min | Adjust RPM to |
| | the solution and mix for an additional 10 minutes | | | have proper stirring |
| 6 | Add Fluopicolide portion-wise (10 minutes) into the | 40 | min | |
| | solution and mix for an additional 30 minutes | | | |
| 7 | Add dispersant Soprophor 3D33 and wetter Ecosurf | 15 | min | |
| | EH6 until mixture is homogenously blended | | | |
| 8 | Mill the blend until PSD is d50 < 3; d90 < 7; d99 < 20 | | | Dispermat TML |
| | | | | at 6000 RPM |
| 9 | Add the missing 20% of the antifoam Silcolapse | 5 | min | |
| | 426R and mix for 15 minutes | | | |
| 10 | Add xanthan gum gel under stirring and mix until | 1+ | hour | |
| | homogeneous mixture is obtained | | | |

TABLE 12
CF1950-16-01. A composition comprising copper-based fungicide
Cu-oxychloride, fluopicolide and polyelectrolyte (4.3%), wherein
the polyelectrolyte is a complex of polyallylamine (PAA) polycation
and CaLS polyanion at a weight % ratio of 1:5.

| CF1950-15-01 | | |
|---|---|---|
| Ingredients | g/L | w/w % |
| Water | 498.12 | 41.5% |
| Propan-1,2-diol | 50.0 | 4.2% |
| PAA (50%) | 8.72 | 0.7% |
| CaLS | 43.6 | 3.6% |
| Cu-oxychloride | 425.89 | 35.5% |
| Fluopicolide | 66.67 | 5.6% |
| Atlox 4913 | 30 | 2.5% |
| Adsee 900 | 12 | 1.0% |
| Silcolapse 426R | 5 | 0.4% |
| Xanthan gum (2% Rhodopol 23) | 60 | 5.0% |
| Total | 1200 | 100.0% |

TABLE 13
CF1950-18-01. A composition comprising copper-based fungicide
Cu-oxychloride, fluopicolide and polyelectrolyte (4.0%),
wherein the polyelectrolyte is a complex of chitosan polycation
and CaLS polyanion at a weight % ratio of 1:4.7.

| CF1950-15-01 | | |
|---|---|---|
| Ingredients | g/L | w/w % |
| Water | 472.44 | 39.4% |
| Propan-1,2-diol | 50.0 | 4.2% |
| Chitosan | 8.00 | 0.7% |
| CaLS | 40.0 | 3.3% |
| Cu-oxychloride | 425.89 | 35.5% |
| Fluopicolide | 66.67 | 5.6% |
| Atlox 4913 | 30 | 2.5% |
| Adsee 900 | 12 | 1.0% |
| Silcolapse 426R | 5 | 0.4% |
| Xanthan gum (2% Rhodopol 23) | 90 | 7.5% |
| Total | 1200 | 100.0% |

TABLE 14
A composition comprising copper-based fungicide CuSO4
Bordeaux mixture 125 g/L + Picoxystrobine 35 g/L +
Prothioconazole 40 g/L, and polyelectrolyte, wherein the
polyelectrolyte comprises only Calcium lignosulfonate polyanion.
Metallic Copper 125 g/L + Picoxystrobin 35 g/L +
Prothioconazole 40 g/L SE

Date: May 10, 2021

| S. No. | Ingredients | % w/w |
|---|---|---|
| 1 | Bodeaux Mix. (9.4@27.22) | 34.29 |
| 2 | Picoxystrobin (2.7@97) | 2.78 |
| 3 | Propylene Glycol | 5.00 |
| 4 | Metasperse 550 S | 1.00 |
| 5 | Borresperse CA | 2.80 |
| 6 | Geropon ® T-77 | 2.00 |
| 7 | Atlox 4894 | 2.00 |
| 8 | SAG 1572 | 0.10 |
| 9 | Proxel GXL | 0.05 |
| 10 | DM water | 36.86 |
| 11 | Prothioconazole (3.0@98) | 3.06 |
| 12 | Armid DM 10 | 3.06 |
| 13 | Emulsogen TS 200 | 1.50 |
| 14 | TEA | 0.50 |
| 15 | Rhodopol 23 (2%) | 5.00 |
| | | 100.00 |

### Sc Preparation:

The required quantity of DM water was taken in the beaker followed by addition of proxel GXL, propylene glycol, Atlox 4894, Borosperse CA, Geropon T77, Metasperse 550S, and ⅓rd part of SAG 1572 with continuous stirring at 350-500 rpm using pitched four blade impeller.
then Bordeaux mixture is added slowly and mixed well with stirring at 350-500 rpm using pitched four blade impeller until homogeneous slurry is obtained.
then picoxystrobin technical is added slowly and mixed well with stirring at 350-500 rpm using pitched four blade impeller until homogeneous slurry is obtained.

The above premix was grinded in bead mill to attain particle size D90<4 micron

The grinded premix was further stirred at 350-500 rpm using pitched four blade impeller for another 30 minutes after milling.

### Ec Preparation:

The required quantity of solvent (Armid DM10) was taken in a beaker and Prothiconazole technical was added and dissolved.

The emulsifier Emulsogen TS200 was added to the above solution and stirred well at 350-500 rpm using pitched four blade impeller until clear solution is obtained.

### Preparation of SE:

EC part was added slowly for 15-20 min under stirring using pitched four blade impeller at 800-1000 rpm to the SC part prepared earlier.

Increase in viscosity was observed during mixing due to emulsification of EC part with aqueous part of SC.

Stirring was continued for about 30 min and the remaining quantity of SAG 1572 was added. The suspoemulsion obtained was mixed for another 15 minute.

The pH of the above mixture was adjusted to be around 6-7 using Triethanol amine. The required quantity of 2% solution of Aghropol 23 was added with stirring at 350-500 rpm using pitched four blade impeller to get final viscosity about 1200-1400 cPs when measured with Spindle 62 at 12 RPM.

### Example 2—Biological Tests

Test 1. Preventive Treatment Towards P. pachyrhizi Strain THAI1 on Soybean

The four new liquid copper prototype formulations of Tables 3-6 and Difere were tested at five rates (0.0075-0.075-0.75-7.5 and 75 g copper metal/ha, corresponding to 500-50-5-0.5 and 0.05 mg a.i./L for Difere reference (Dicopper chloride trihydroxide; CAS #1332-40-7, Cu2Cl(OH)3 90%) or ppm/0.0022-0.022-0.22-2.2 and 22 g copper metal/ha, corresponding to 148-14.8-1.48-0.148-0.0148 mf of Cu metal/L for copper prototypes) with 0.05% Tween 80. Difere is a commercially available suspension concentrate (SC) formulation containing 588 g/L (58.8% m/v) of copper oxychloride. The fungicides were prepared one hour before treatment in a volume of water corresponding to 150 l/ha.

The fungicides were sprayed by the aim of a hand sprayer in presence of Tween 80 (0.05%). Control true leaves are treated with distilled water. After treatment soybean leaves were left to dry at room temperature and then placed adaxial face up on 120×120 cm Petri dishes containing 0.4 water agar supplemented with antibiotic and anti-senescing product (3 replicates per treatment).

Twenty-four hours (24 h) after treatment (preventive treatment), soybean true leaves plantlets were inoculated with a calibrated uredospores suspension of the reference P. pachyrhizi strain THAI1. The inoculated soybean leaves are incubated in a climatic chamber.

TABLE 7
EC50 values of 4 copper prototypes, compared to Difere.

| Product | EC₅₀ | |
|---|---|---|
| DT-CE-C4-345-08T + 0.05% Tween 80 | 0.0052 | g Copper Metal/Ha |
| DT-CE-C4-345-09T + 0.05% Tween 80 | 0.0100 | g Copper Metal/Ha |
| DT-CE-C4-345-10T + 0.05% Tween 80 | 0.0590 | g Copper Metal/Ha |
| DT-CE-C4-345-11T + 0.05% Tween 80 | 0.0095 | g Copper Metal/Ha |
| Difere + 0.05% Tween 80 | 0.600 | g Copper Metal/Ha |

Dose-response effect of the 4 new Copper prototypes, DT-CE-C4-345-08T to -11T and Difere+0.05%˜ Tween 80, applied preventively, towards P. pachyrhizi strain THAI1 on soybean leaves in controlled conditions.

| | 0 g | 0.0022 g | 0.022 g | 0.22 g | 2.2 g | 22 g |
|---|---|---|---|---|---|---|
| Product | AI/Ha | AI/Ha | AI/Ha | AI/Ha | AI/Ha | AI/Ha |
| DT-CE-C4- | 1088.8 +/− | 671.3 +/− | 330.0 +/− | 221.2 +/− | 13.5 +/− | 0.0 +/− 0.0i |
| 345-08T | 18.9a | 30.7d (38.3%) | 43.2fg (69.7%) | 16.3gh (79.7%) | 6.8i (98.8%) | (100.0%) |
| DT-CE-C4- | 1088.8 +/− | 1046.3 +/− | 281.3 +/− | 43.5 +/− | 1.5 +/− 1.5i | 1.5 +/− 1.5i |
| 345-09T | 18.9a | 89.3a (3.9%) | 45.5fg (74.2%) | 19.9i (96.0%) | (99.9%) | (99.9%) |
| DT-CE-C4- | 1088.8 +/− | 975.0 +/− | 843.8 +/− | 132.0 +/− | 15.0 +/− | 0.0 +/− 0.0i |
| 345-10T | 18.9a | 36.9ab (10.4%) | 87.9c (22.5%) | 38.5hi (87.9%) | 5.9i (98.6%) | (100.0%) |
| DT-CE-C4- | 1088.8 +/− | 806.3 +/− | 393.8 +/− | 43.5 +/− | 9.7 +/− 7.6i | 8.3 +/− 8.3i |
| 345-11T | 18.9a | 38.1c (25.9%) | 33.8ef (63.8%) | 11.7i (95.9%) | (99.1%) | (99.2%) |
| Product | 0 g | 0.0075 g | 0.075 g | 0.75 g | 7.5 g | 75 g |
| | AI/Ha | AI/Ha | AI/Ha | AI/Ha | AI/Ha | AI/Ha |
| Difere | 1088.8 +/− | 1083.8 +/− | 903.8 +/− | 506.3 +/− | 29.3 +/− | 1.5 +/− 1.5i |
| | 18.9a | 64.1a (0.5%) | 26.3bc (17.0%) | 23.4^{e} (53.5%) | 5.2i (97.3%) | (99.9%) |

^{a}Each value corresponds to mean of 3 replicates (Petri dishes) of 3 soybean leaf each +/− standard error. The values between brackets correspond to the fungicide efficacy in percent of the untreated control. The values followed by the same letter are not significantly different according to the Newman & Keuls test (P = 0.005).

Test 2. Preventive Treatment Towards Phytophthora infestans Strain Pi96 in Potato

The 4 copper prototypes DT-CE-C4-345-08T, DT-CE-C4-345-09T, DT-CE-C4-345-10T, DT-CE-C4-345-11T and the reference copper fungicide Kocide Opti were applied on potato whole plants at five rates (750, 450, 375, 150, 15 gr metallic copper/Ha) a second copper fungicide reference, Kocide 2000, was applied at 375 and 150 gr metallic copper/Ha. All copper formulations were supplemented with Tween 80 0.05% and applied by the aim of a hand-sprayer calibrated to deliver 300 L/ha. After 24 hours, the plants were inoculated with a calibrated sporangia suspension of P. infestans strain Pi96. Following inoculation, the plants were transferred to a climatic chamber (20° C./16° C.-16 h light/day 8 h dark/night) under saturated humidity. Disease assessment was carried out 7 days after infection by estimating the Disease Severity Index (DSI). The DSI is calculated per leaf, a minimum of 12 leaves (from a minimum of 2 plants) are considered for each condition.

Results of test 1, show that copper compositions according to the invention brings an added value in terms of treatment towards P. pachyrhizi strain THAI1, when compared to the Difere commercial product reference control. The efficacy results are shown in Tables 1 and 2. Especially, compositions DT-CE-C4-345-09T and DT-CE-C4-345-11T outperformed control copper over the whole range, as is clearly shown in FIG. 2. The EC50 values of the copper compositions according to the invention were 10 to 100 fold lower than that of the Difere commercial product reference control (see Table 7).

Results of test 2 in FIG. 2 show that the fungicidal efficacy of the copper compositions according to the invention were superior to that of the Kocide commercial product reference control

It was surprising that the compositions comprising copper-polyelectrolyte macromolecular complexes according to the invention showed improved fungicidal efficacy compared to commercial product. It is reasonable to expect that when copper sulfate is replaced with another copper-based fungicide, a similar improvement in fungicidal efficacy will be observed

### Test 3. Improved Rainfastness.

FIG. 3 shows the improved rainfastness of DT-CE-C4-345-08T and DT-CE-C4-345-10T in soybean compared to other copper formulations. Soybean plants were treated adaxial with Copper BM formulations at 300 ppm copper using airbrush device (AB-350, Conrad Electronics). After 4 hours the plants were watered with 40 mm rain/hour and left to dry for 24 hours. The next day, the plants were inoculated adxial with spore suspension of Phakopsora pachyrhizi strain BR05 at 1 mg spores/ml and incubated for one night. The next day the leaves were detached and placed adaxial side up in petri dishes+3 mL water (3 leaflets per dish) and incubated at 22° C. (16 h light/8 h dark). The number of lesions was evaluated after 13 days.

### Test 4. Lack of Toxicity.

FIG. 4 shows no phytotoxicity of DT-CE-C4-345-08T and DT-CE-C4-345-10T towards Soybeans (Glycine max Abelina). Two plants with two trifolia each were treated with different rates of fungicides (2.9 gr metallic copper/lit or 11.6 gr metalic copper/lit) (tap water is used as a control) on day 0 and on day 5 of the experiment. Treatment was performed via spraying with an Airbrush Device (AB-350, Conrad Electronics) and the plants were kept at 22° C. (16 h light/8 h dark). The experiment was evaluated on day 15. A. water control B. DT-CE-C4-345-08T C. DT-CE-C4-345-10T.

1. A combination of copper-based fungicide and polyelectrolyte.

2. The combination of claim 1, wherein the combination is a macromolecular complex comprising the copper-based fungicide and the polyelectrolyte.

3. The combination of claim 2, wherein the macromolecular complex is characterized by intermolecular, non-covalent interactions between the polyelectrolyte and the copper-based fungicide.

4. The combination of any one of claims 1-3, wherein the copper-based fungicide is selected from the group consisting of copper oxychloride, copper hydroxide, copper sulfate, and any combination thereof.

5. The combination of any one of claims 1-4, wherein the copper-based fungicide is copper sulfate.

6. The combination of any one of claims 1-3, wherein the polyelectrolyte is a complex of polycation and polyanion, the polyelectrolyte comprises at least one polyanion, or the polyelectrolyte is a polyanion.

7. The combination of claim 4, wherein the polyanion is selected from the group consisting of xanthan gum, alginate, pectin, lignin compound, carrageenan, humic acid, fulvic acid, angico gum, gum Kondagogu, sodium alkyl naphtalene sulfonate, poly-γ-glutamic acid, maleic starch half-ester, carboxymethyl cellulose, chondroitin sulphate, dextran sulphate, and hyaluronic acid, and synthetic origin, for example poly(acrylic acid), polyphosphoric acid, poly(L-lactide), and any combination thereof.

8. The combination of claim 6 or 7, wherein the polyelectrolyte comprises a lignin compound.

9. The combination of claim 8, wherein the lignin compound is lignosulfonate.

10. The combination of any one of claims 1-4, wherein the polyelectrolyte is a complex of a polyanion and a polycation.

11. The combination of claim 7, wherein the polycation is selected from the group consisting of poly-L-lysine, epsilon-poly-L-lysine, poly-L-arginine, polyallylamine, chitosan oligosaccharide, chitosan and any combination thereof.

12. The combination of claim 11, wherein the polycation is chitosan.

13. The combination of any one of claims 1-4, wherein the polyelectrolyte is a polyanion and is substantially free or free of a polycation.

14. The combination of any one of claims 1-6, wherein the weight ratio between the polyelectrolyte and the metallic copper in the copper-based fungicide is between 1:10 to 1:1.

15. The combination of claim 5, wherein the weight ratio between the polyelectrolyte and the metallic copper in the copper-based fungicide is 1:3.5.

16. The combination of claim 6, wherein the weight ratio between the polyelectrolyte and the metallic copper in the copper-based fungicide in the combination and/or composition described herein is 1:4.4.

17. A composition comprising the combination of any one of claims 1-16 and at least one agriculturally acceptable additive.

18. The composition of claim 17, wherein the combination is a macromolecular complex and the concentration of the macromolecular complex in the composition is between 10 and 40 g/kg.

19. The composition of claim 17 or 18, wherein the concentration of the metallic copper in the composition is 0.1% to 10% by weight based on the total weight of the composition.

20. The composition of claim 19, wherein the concentration of the metallic copper in the composition is 2.9% by weight based on the total weight of the composition.

21. The composition of any one of claims 17-20, wherein the concentration of the polyelectrolyte in the composition is 0.01-10% by weight based on the total weight of the composition.

22. The composition of claim 21, wherein the concentration of the polyelectrolyte in the composition is about 3% by weight based on the total weight of the composition.

23. The composition of any one of claims 17-22, wherein further comprises an organic phase.

24. The composition of any one of claims 17-23, wherein the organic phase is oil-organic solvent drops.

25. The composition of any one of claims 17-24, comprising at least one additional fungicide which is dissolved in the water-immiscible carrier.

26. The composition of any one of claims 17-23, comprising at least one additional fungicide which is suspended in the water carrier.

27. The composition of any one of claims 17-23, comprising at least two additional fungicides which are dissolved in the water-immiscible carrier.

28. The composition of any one of claims 17-23, comprising at least two additional fungicides which are suspended in the water carrier.

29. The composition of any one of claims 17-23, comprising at least two additional fungicides wherein one is dissolved in the water-immiscible carrier and the other is suspended in the water carrier.

30. The composition of any one of claims 17-29, comprising an agriculturally acceptable additive selected from the group consisting of agriculturally acceptable carriers, buffers, acidifiers, defoaming agents, thickeners, drift retardants, surfactant, pigments, wetting agents, safeners, preservatives, and any combination thereof.

31. The composition of claim 30, wherein the composition comprises at least one agriculturally acceptable carrier.

32. The composition of claim 31, wherein the agriculturally acceptable carrier is water.

33. The composition of claim 32, wherein the composition comprises 40-80% by weight of water.

34. The composition of claim 32 or 33, wherein the composition comprises 50-55% by weight of water.

35. The composition of any one of claims 17-34, wherein the composition comprises at least one dispersant.

36. The composition of claim 35, wherein the dispersant is a modified styrene acrylic polymer.

37. The composition of claim 35, wherein the composition comprises at least one anionic dispersant and at least one non-ionic surfactant.

38. The composition of any one of claims 35-37, wherein the concentration of the dispersant(s) in the composition is 0-15% by weight based on the total weight of the composition.

39. The composition of any one of claims 17-38, wherein the composition comprises at least one anti-foaming agent.

40. The composition of claim 39, wherein the anti-foaming agent is silicone-based.

41. The composition of claim 39 or 40, wherein the concentration of the anti-foaming agent is 0.01-5% by weight based on the total weight of the composition.

42. The composition of any one of claims 17-41, wherein the composition comprises at least one anti-freezing agent.

43. The composition of claim 42, wherein the anti-freezing agent is selected from the group consisting of glycerine, ethylene glycol, hexyleneglycol, propylene glycol and any combination thereof.

44. The composition of claim 42 or 43, wherein the anti-freezing agent is propylene glycol.

45. The composition of any one of claims 42-44, wherein the concentration of the antifreezing agent in the composition is 1-10% by weight based on the total weight of the composition.

46. The composition of any one of claims 17-45, wherein the composition comprises at least one surfactant.

47. The composition of claim 46, wherein the surfactant is selected from the group consisting of alkyl-end-capped ethoxylate glycol, alkyl-end-capped alkyl block alkoxylate glycol, dialkyl sulfosuccinate, phosphated esters, alkyl sulfonates, alkyl aryl sulfonates, tristyrylphenol alkoxylates, natural or synthetic fatty acid alkoxylates, natural or synthetic fatty alcohols alkoxylates, alkoxylated alcohols, block copolymers, and any combination thereof.

48. The composition of claim 46 or 47, wherein the composition comprises at least one anionic surfactant.

49. The composition of claim 48, wherein the concentration of anionic surfactant in the composition is between 1% to 3% by weight based on the total weight of the composition.

50. The composition of any one of claims 38-49, wherein the composition comprises at least one non-ionic surfactant.

51. The composition of claim 50, wherein the concentration of non-ionic surfactant in the composition is between 0.1% to 0.5% by weight based on the total weight of the composition.

52. The composition of any one of claims 38-51, wherein the composition comprises a combination of anionic and non-ionic surfactants.

53. The composition of any one of claims 38-52, wherein the total concentration of the surfactant(s) in the composition is 2-5% w/w by weight based on the total weight of the total composition.

54. The composition of any one of claims 17-53, wherein the composition comprises at least one wetting agent.

55. The composition of claim 54, wherein the wetting agent is butyl block copolymer.

56. The composition of claim 54, wherein the wetting agent is decyl alcohol ethoxylate.

57. The composition of claim 54 to 56, wherein the concentration of the wetting agent in the composition is 1-10% by weight based on the total weight of the composition.

58. The composition of any one of claims 17-57, wherein the composition comprises at least one rheology modifier.

59. The composition of claim 58, wherein the rheology modifier is selected from the group consisting of agar, alginic acid, alginate, carrageenan, gellan gum, xanthan gum, succinoglycan gum, guar gum, acetylated distarch adipate, acetylated oxidised starch, arabinogalactan, ethyl cellulose, methyl cellulose, locust bean gum, starch sodium octenylsuccinate, triethyl citrate, and any combination thereof.

60. The composition of claim 58 or 59, wherein the rheology modifier is xanthan gum.

61. The composition of any one of claims 58-60, wherein the concentration of the rheology modifier in the composition is 0.01-10% by weight based on the total weight of the composition.

62. The composition of any one of claims 17-61, wherein the composition comprises at least one preservative.

63. The composition of claim 62, wherein the preservative is a biocide.

64. The composition of claim 62 or 63, wherein the concentration of the preservative in the composition is 0.01-5% by weight based on the total weight of the composition.

65. The composition of any one of claims 17-64, wherein the composition comprises at least one additional bioactive ingredient.

66. The composition of any one of claims 17-65, wherein the additional bioactive ingredient in the composition is fluopicolide fungicide.

67. The composition of any one of claims 17-65, wherein the additional bioactive ingredients in the composition are prothioconazole and picoxystrobin fungicides.

68. The composition of any one of claims 17-65, comprising additional fungicides in the composition, wherein the preferred dispersant combinations are a mixture of an anionic tristyrylphenol phosphate surfactant and a high HLB nonionic polyalkylene oxide block polymer surfactant.

69. The composition of any one of claims 17-65, comprising additional fungicides in the composition, wherein the preferred dispersant combinations are a mixture of an anionic tristyrylphenol phosphate surfactant and a nonionic alcohol ethoxylate.

70. The composition of any one of claims 17-69, wherein:
a. the composition has viscosity in the range of 1500-1800 cPs (measured with a Brookfield spindle 63 at 12 rpm),
b. the composition comprises particles with a particle size distribution (d90) is 10 microns or less,
c. the composition has a pH in the range of 5.0-7.5, and/or
d. the composition has a density (g/ml) of 1.26±0.05 at 25° C.

71. The composition of any one of claims 17-70, wherein the composition is in the form of a suspension concentrate (SC), a water dispersible granule (WG), a wettable powder (WP), a dispersion concentrate (DC), a dry powder seed treatment (DS), a water slurriable powder (WS), or a flowable seed treatment (FS).

72. A pesticidal delivery system comprising the combination or composition of any one of claims 1-71.

73. A method of treating a plant, or a part of a plant, against a pathogen, comprising contacting the plant, or part of the plant, with an effective amount of the combination, composition or delivery system of any one of claims 1-71 so as to thereby treat the plant or part of the plant against the pathogen.

74. The method of claim 73, wherein treating comprises:
a. preventing, reducing and/or eliminating the presence of the pathogen on the plant, or part of the plant,
b. controlling diseases caused by the pathogen, and/or
c. prolonging the controlling effect of the copper-based herbicide.

75. The method of claim 73 or 74, wherein the combination, composition or delivery system is applied at an amount between 0.001 g/ha to 1000 g/ha of copper metal.

76. The method of claim 75, wherein:
a. the combination, composition, and/or delivery system is applied at an amount of about 0.0022 g/ha, 0.022 g/ha, 0.22 g/ha, 2.2 g/ha or 22 g/ha of copper metal,
b. the combination, composition, and/or delivery system is applied at an amount of about 0.0075 g/ha, 0.075 g/ha, 0.75 g/ha, 7.5 g/ha or 75 g/ha of copper metal,
c. the combination, composition, and/or delivery system is applied at an amount of about 0.0052 g/ha, 0.001 g/ha, 0.059 g/ha, or 0.0095 g/ha of copper metal, or
d. the combination, composition, and/or delivery system is applied at an amount of about 15 g/ha, 150 g/ha, 375 g/ha, 450 g/ha, or 750 g/ha of copper metal.

77. A method of promoting growth of a crop plant in the presence of a pathogen comprising contacting the plant, or part of the plant, with an effective amount of the combination, composition or delivery system of any one of claims 1-71 so as to thereby promote the growth of the crop plant treat than if the same type and amount of copper base fungicide is formulated in the absence of polyelectrolyte.

78. The method of claim 77, wherein the method is effective for improving plant vigor and/or increasing crop yield.

79. A method for improving efficacy of a copper-based fungicide comprising interacting the copper-based fungicide with a polyelectrolyte prior to application of the copper-based fungicide to a plant, a plant part, and/or soil.

80. A method for controlling the release rate of copper cation from a copper-based fungicide comprising interacting the copper-based fungicide with a polyelectrolyte prior to application of the copper-based fungicide to a plant, a plant part, and/or soil.

81. A method for (i) increasing biological activity of a copper-based fungicide on a target, (ii) increasing persistence of a copper-based fungicide into a target, (iii) increasing retention of a copper-based fungicide by a target, (iv) increasing absorbance of a copper-based fungicide by a target, or (v) increasing or enhancing bioavailability of a copper-based fungicide to a target, wherein the method comprises interacting the copper-based fungicide with a polyelectrolyte prior to application of the copper-based fungicide to a plant, a plant part, and/or soil.

82. A method for (i) reducing drift of a copper-based fungicide, (ii) increasing leaf adhesion of a copper-based fungicide, (iii) increasing rainfastness of a copper-based fungicide, (iv) increasing persistence of a copper-based fungicide, and/or (v) reducing phytotoxicity of a copper-based fungicide, wherein the method comprises interacting the copper-based fungicide with a polyelectrolyte prior to application of the copper-based fungicide.

83. A process for producing a macromolecular complex comprising a copper-based fungicide and a polyelectrolyte comprising the following steps:
(a) providing an aqueous composition of the polyelectrolyte,
(b) mixing the copper-based fungicide into the aqueous composition, and
(c) thereby producing the macromolecular complex of the polyelectrolyte and the copper-based fungicide in an aqueous composition.

84. The process of claim 83 further comprising a step of milling or grinding the resultant macromolecular complexes to reduce their particle size such that the particles have a d90 of 10 microns or less.

85. A process for preparing the composition of any one of claims 17-71, comprising mixing the macromolecular complex with at least one agriculturally acceptable additive.

86. The process of claim 85, wherein the macromolecular complex is prepared by pre-mixing the polyelectrolyte and the copper-based fungicide prior to addition of any agriculturally acceptable additive.

87. The process of claim 86, wherein the macromolecular complex is prepared by pre-mixing the polyelectrolyte and the copper-based fungicide prior to addition of any additional fungicides.

88. A process for preparation of a composition comprising copper-based fungicides and polyelectrolyte macromolecular complex, the process comprising preparing a solution of the antifreeze in water, adding the polyanion and polycation to form the polyelectrolyte macromolecular complex, adding the dispersant and wetter, adding the copper-based fungicide, adding 80% of the antifoam agent, milling of the formulation to the desired particle size range, adding the remaining 20% of the antifoam agent, adding a solution of the rheology modifying agent in water and stirring until an homogeneous mixture is obtained.
